(19) United States
(12) Patent Application Publication
(10) Pub. No.: US 2015/0116367 A1
(43) Pub. Date: Apr. 30, 2015

(54) INFORMATION PROCESSING DEVICE, DISPLAY ENLARGING METHOD, AND COMPUTER READABLE MEDIUM

(71) Applicant: NEC Corporation, Tokyo (JP)

(72) Inventor: TORU YADA, Tokyo (JP)

(73) Assignee: NEC Corporation

(21) Appl. No.: 14/524,651

(22) Filed: Oct. 27, 2014

(30) Foreign Application Priority Data
Oct. 31, 2013 (JP) 2013-226328

(51) Int. Cl. G09G 5/373; G06T 3/40

(52) U.S. Cl. CPC G09G 5/373; G06T 3/40; G06T 3/4092; G09G 2354/00; G09G 2340/045
USPC 345/661

(57) ABSTRACT

An information processing device of the invention includes an input control unit which calculates an enlargement ratio, based on an instruction to enlarge objects displayed on a screen of a display device, and generates enlargement instruction information including enlargement ratio information representing the enlargement ratio, an enlargement process unit which executes an enlargement process of enlarging a plurality of objects in drawing data in a state that the objects do not overlap each other, based on the enlargement ratio information and the drawing data including object information relating to display of the objects, and generates enlarged drawing data including object information relating to the enlarged objects, and a display control unit which displays the enlarged objects on a screen of the display device, based on the enlarged drawing data.

This application is based upon and claims the benefit of priority from Japanese Patent Application No. 2013-226328, filed on Oct. 31, 2013, the disclosure of which is incorporated herein in its entirety by reference.

### TECHNICAL FIELD

The present invention relates to a technique of enlarging display on a whiteboard system or the like with use of an information processing device (computer).

### BACKGROUND ART

As networks and computers have been developed, a whiteboard system that is virtually shared between users has been available, as an alternative for a physical whiteboard. In the whiteboard system, users can share a whiteboard in which various objects are written from a terminal of a user, on the screens of the respective terminals of the users. The user can dispose objects such as a text, a rectangle, a circle, a straight line, and an arrow on the whiteboard by operating the terminal thereof.

Further, in recent years, as mobile terminals have been developed, there is a need for displaying these whiteboards on a smaller screen. In this case, visibility of whiteboard display may not be good because the font size of text is also reduced due to a property that the screen size of a mobile terminal is small. In view of the above, a function of enlarging display (enlarged display) is provided in a whiteboard system in many cases.

As a method for enlarging display (enlarged display method), for instance, there is known a method such that a whiteboard screen is enlarged and displayed with respect to the coordinates designated by the user. In this method, a portion intended by the user is equally enlarged and displayed on the whiteboard, including objects, and margins on the outside of the objects. This is just like a method such that enlarging and displaying characters on paper through a magnifying lens is implemented on an electronic screen. In the enlarged display method, a portion of the outside of an enlarged area on a screen before enlargement may not be displayed, because the portion is deviated from a screen after enlargement.

Further, as a related art, Japanese Laid-open Patent Publication No. 2008-310443 (hereinafter, called as Document 1) discloses a method such that when users of an electronic conference system have information terminals by which a shared screen is operable, the users can effectively utilize the respective terminals. In the method described in Document 1, first of all, an image processing device acquires terminal information for identifying the information terminal by acquiring means. The image processing device determines a screen configuration in accordance with an operation screen format in conformity to the display ability of the information terminal, based on the terminal information. Thus, the image processing device is capable of assigning a screen configuration optimum for each of the information terminals when the shared screen is operated.

Further, Japanese Laid-open Patent Publication No. 2007-249695 (hereinafter, called as Document 2) discloses a method such that a video and a cursor image are shared between information terminals communicatively connected to each other via a network. In the method described in Document 2, one of the information terminals distributes cursor information along with image data. The other of the information terminals displays, on a display device, an image obtained by combining a cursor image generated from the cursor information with a video reproduction screen. Thus, the information terminals share a video and a cursor image.

Further, Japanese Laid-open Patent Publication No. 2006-129190 (hereinafter, called as Document 3) discloses a method such that, in an image sharing system, even when the frame rate of an image displayed by presentation is low, the movement of a mouse cursor is smoothly displayed. In the method described in Document 3, a distribution server can transmit image information, image-captured data, and a cursor shape to be distributed by enlargement or reduction with use of a predetermined technique. Further when the distribution server transmits an identifier of a cursor shape, in place of an image in the form of a cursor, an enlargement/reduction ratio of image data is transmitted to a client terminal. The client terminal displays an image by enlargement or reduction, and restores the cursor, based on the transmitted identifier of a cursor shape and based on the transmitted enlargement/reduction ratio of image data.

Further, Japanese Laid-open Patent Publication No. 2010-170354 (hereinafter, called as Document 4) discloses a method such that cursors of the users who participate in a group work are displayed on screens of terminal devices used by the respective users in such a manner that each cursor is associated with a corresponding user. The method described in Document 4 includes one large display device and terminal devices. Each of the terminal devices functions as a device for displaying shared information.

In the aforementioned enlarged display methods, however, a portion of the image may not be displayed on a screen of the whiteboard after enlarged display, whereas the portion is displayed on a screen before enlarged display. Specifically, when there is an object on a portion that is not displayed after enlarged display, the object may completely disappear from a screen by enlargement.

Further, the techniques disclosed in Documents 1 to 4 have failed to consider a countermeasure against complete disappearance of an object from a screen when a display is enlarged.

### SUMMARY

An exemplary objective of the invention is to provide an information processing device and the like for enlarging and displaying objects in such a manner as to avoid complete disappearance of an object included in a screen before enlarged display by enlargement.

To accomplish the above objective, an information processing device of the invention has the following configuration.

Specifically, the information processing device of the invention includes,

an input control unit which calculates an enlargement ratio, based on an instruction to enlarge objects displayed on a screen of a display device, and generates enlargement instruction information including enlargement ratio information representing the enlargement ratio;

an enlargement process unit which executes an enlargement process of enlarging a plurality of objects in drawing data in a state that the objects do not overlap each other, based on the enlargement ratio information and the drawing data including object information relating to display of the objects, and generates enlarged drawing data including object information relating to the enlarged objects; and

a display control unit which displays the enlarged objects on a screen of the display device, based on the enlarged drawing data.

Further, in order to accomplish the above objective, a display enlarging method of the invention includes,

calculating an enlargement ratio, based on an instruction to enlarge objects displayed on a screen of a display device;

executing an enlargement process of enlarging a plurality of objects in drawing data in a state that the objects do not overlap each other, based on enlargement instruction information including enlargement ratio information representing the enlargement ratio and the drawing data including object information relating to display of the objects; and

displaying enlarged objects on a screen of the display device, based on enlarged drawing data including object information relating to the enlarged object.

Further, the above objective is also accomplished by a computer program that implements the information processing device and the display enlarging method including the above configurations by a computer, and by a computer-readable storage medium storing the computer program.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration of a terminal device 1 in a first exemplary embodiment of the invention;

FIG. 2 is a block diagram illustrating a terminal device 100, and an input device 110 and a display device 111 to be connected to the terminal device 100, as an example of a configuration of a second exemplary embodiment of the invention;

FIG. 3 is a flowchart illustrating an enlargement procedure to be performed by the terminal device 100 in the second exemplary embodiment;

FIG. 4 is a diagram illustrating an example of a screen including objects in the second exemplary embodiment;

FIG. 5 is a block diagram illustrating a configuration of a shared whiteboard system in a third exemplary embodiment of the invention, and in a modification thereof;

FIG. 6 is an image diagram for representing a problem relating to a positional relationship between an image indicating a position (position indication image), and an object after enlargement in a shared whiteboard function;

FIG. 7 is a flowchart illustrating an enlargement procedure to be performed by a terminal device 300 in the third exemplary embodiment;

FIG. 8 is a flowchart illustrating a transmission operation, in a shared display function of a position indication image, to be performed by the terminal device 300 in the third exemplary embodiment;

FIG. 9 is a flowchart illustrating a receiving operation, in the shared display function of a position indication image, to be performed by a terminal device 310 in the third exemplary embodiment;

FIG. 10 is a diagram illustrating an example of a screen image for representing an enlargement procedure in the third exemplary embodiment;

FIG. 11 is a diagram illustrating an example of a screen image for representing the enlargement procedure in the third exemplary embodiment;

FIG. 12 is a diagram illustrating an example of a screen on a transmission side and on a receiving side when coordinates of a position indication image are shared in the third exemplary embodiment;

FIG. 13 is a diagram illustrating an example of a screen when a new object is added in the third exemplary embodiment;

FIG. 14 is a diagram illustrating an example of a screen when the screen including two objects whose coordinates are partly overlapped is enlarged in the third exemplary embodiment;

FIG. 15 is a diagram illustrating an example of a screen when the screen including partly overlapping two objects is enlarged in a first modification of the third exemplary embodiment;

FIG. 16 is a diagram illustrating an example of a screen when the screen including two objects in proximity to each other is enlarged in the first modification of the third exemplary embodiment;

FIG. 17 is a diagram illustrating an example of a screen when a display position of an object is changed with respect to a marginal area having a belt shape, as a result of enlargement in a second modification of the third exemplary embodiment; and

FIG. 18 is a diagram exemplifying a configuration of a computer which is applicable to the terminal devices and to the shared whiteboard system in the respective exemplary embodiments of the invention and in the modifications thereof.

### EXEMPLARY EMBODIMENT

In the following, exemplary embodiments of the invention are described in detail referring to the drawings.

### First Exemplary Embodiment

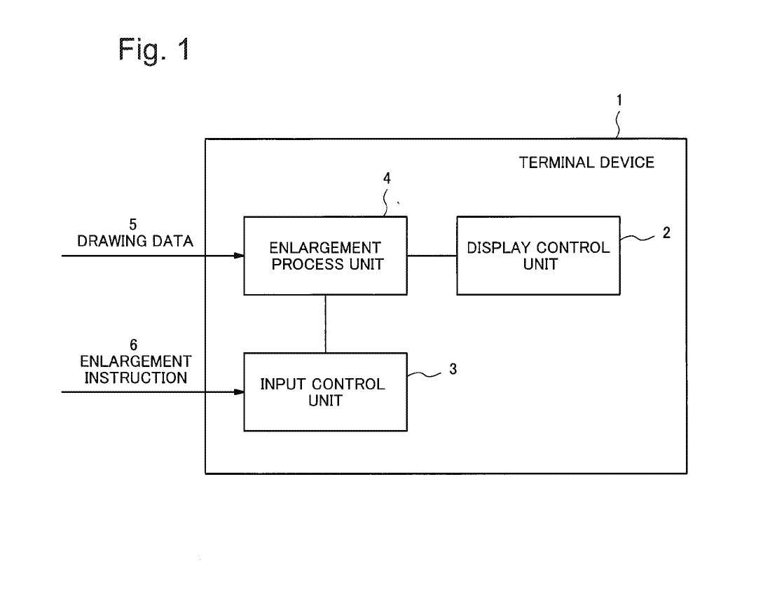

FIG. 1 is a block diagram illustrating a configuration of a terminal device 1 in a first exemplary embodiment of the invention. Referring to FIG. 1, the terminal device 1 in the present exemplary embodiment includes a display control unit 2, an input control unit 3, and an enlargement process unit 4. The terminal device 1 is an example of a device that implements an information processing device of the invention.

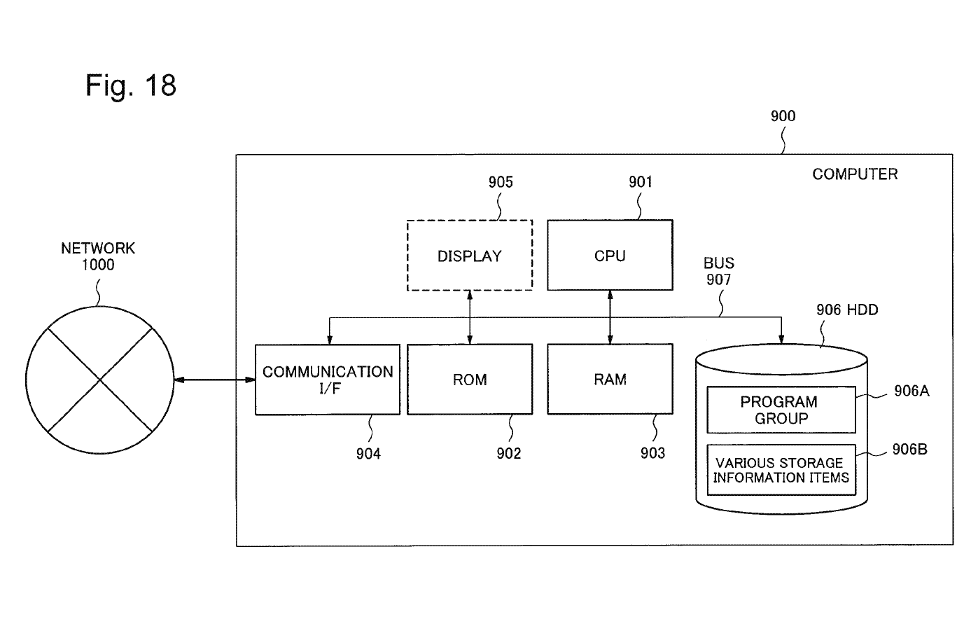

The terminal device 1 may be constituted of a general computer (information processing device) operated by controlling a computer program (software program) to be executed with use of a CPU (Central Processing Unit: not illustrated). Alternatively, the respective units of the terminal device 1 may be constituted of a dedicated hardware device or a logic circuit. A hardware configuration example in which the terminal device 1 is implemented by a computer is described later referring to FIG. 18.

Further, the present exemplary embodiment is described based on the premise that the user instructs to enlarge objects displayed in advance on a screen of an unillustrated display device, with respect to the terminal device 1. Objects are, for instance, drawing elements such as a text, a rectangle, a circle, a straight line, and an arrow, which are displayed on a screen or the like of an unillustrated display device (hereinafter, “a screen or the like” is simply called as “a screen”). Further, objects may be a video to be output by a video playback software, and an image to be output by an application, such as display of a document to be output by a word-processor software.

The input control unit 3 allows the user to input an instruction (enlargement instruction) 6 to enlarge the objects. In the following, an operation of inputting the enlargement instruction 6 may also be called as “an enlargement operation”. The user performs an enlargement operation, with use of an unillustrated input device to be controlled by the input control unit 3. For instance, the user may click (select) the edge of any object displayed on the screen of the unillustrated display device, and drag the object until an intended size is obtained with use of a pointing device (input device) such as a mouse for an enlargement operation. Alternatively, for instance, the user may press an enlargement button displayed on the screen of the unillustrated display device with use of a mouse, and input an intended enlargement ratio via a keyboard. In this way, the user may perform an enlargement operation with use of two or more input devices. The enlargement operation method is not limited to the above methods. In any of the enlargement operation methods, the input control unit 3 calculates at least an enlargement ratio intended by the user, based on the enlargement operation.

Further, the input control unit 3 outputs, to the enlargement process unit 4, enlargement instruction information relating to the enlargement instruction 6 received from the user. The enlargement instruction information includes at least enlargement ratio information representing an enlargement ratio.

The enlargement process unit 4 acquires drawing data 5 including information (object information) relating to display of objects. For instance, the drawing data 5 is data including various information items necessary for displaying a screen in the unillustrated display device. Specifically, the drawing data 5 includes object information relating to all the objects included in a screen. Further, the object information includes at least disposition information representing a display position of an object (coordinates on a screen), and size information representing the size of an object. The object information may additionally include shape information representing the shape of an object, image bitmap information, and color information representing the color of an object, for instance.

The enlargement process unit 4 may receive the drawing data 5 from an unillustrated external device via a network, and record the received drawing data 5 in an unillustrated storage device for acquiring the drawing data 5. Alternatively, the enlargement process unit 4 may read the drawing data 5 from an unillustrated storage device via an internal bus for acquiring the drawing data 5. Further alternatively, the enlargement process unit 4 may allow the user to input the drawing data 5 based on an operation with use of an unillustrated input device for acquiring the drawing data 5.

Further, the enlargement process unit 4 enlarges each of the objects included in the drawing data 5, based on the enlargement instruction information received from the input control unit 3. When the objects are enlarged, the enlargement process unit 4 enlarges the objects in the drawing data 5 in a state that the objects do not overlap each other. In particular, when the objects in the drawing data 5 do not overlap each other, it is preferable for the enlargement process unit 4 to enlarge the objects in a state that the objects do not overlap each other. Further, when some of the objects in the drawing data 5 overlap each other, it is preferable to enlarge the objects in a state that these objects do not overlap with other objects, while maintaining the overlapping state. Specifically, the enlargement process unit 4 equally enlarges each of the objects in such a range that the objects disposed away from each other do not overlap each other, based on the object information included in the drawing data 5, and in accordance with the enlargement ratio information included in the enlargement instruction information. Further, the enlargement process unit 4 generates “enlarged drawing data” including object information relating to each of the enlarged objects. The enlargement process unit 4 outputs the generated enlarged drawing data to the display control unit 2.

The display control unit 2 outputs data to a display device (not illustrated) based on the enlarged drawing data received from the enlargement process unit 4 to display a screen including enlarged objects. The display device may be built in the display control unit 2, or may be externally mounted.

As described above, the present exemplary embodiment has an advantage of enlarging and displaying objects in such a manner as to avoid complete disappearance of an object included in a screen before enlarged display by enlargement.

The above advantage is obtained because the enlargement process unit 4 enlarges only objects, in place of enlarging the entirety of a screen. Specifically, the enlargement process unit 4 reduces the margin as a portion where an object is not displayed so as to create a display area, which is required as the objects are enlarged.

### Second Exemplary Embodiment

In this section, a second exemplary embodiment based on the first exemplary embodiment is described. In the following, the features of the second exemplary embodiment are mainly described. Further, the constituent elements in the second exemplary embodiment including the same configuration as in the first exemplary embodiment are indicated with the same reference numerals as the reference numerals in the first exemplary embodiment, and repeated detailed description of the constituent elements in the second exemplary embodiment is omitted.

The present exemplary embodiment is different from the first exemplary embodiment in a point that the present exemplary embodiment includes an image generating unit 101 capable of disposing objects on a screen, based on an operation (input) with use of an input device 110 for generating the drawing data 5 in the first exemplary embodiment.

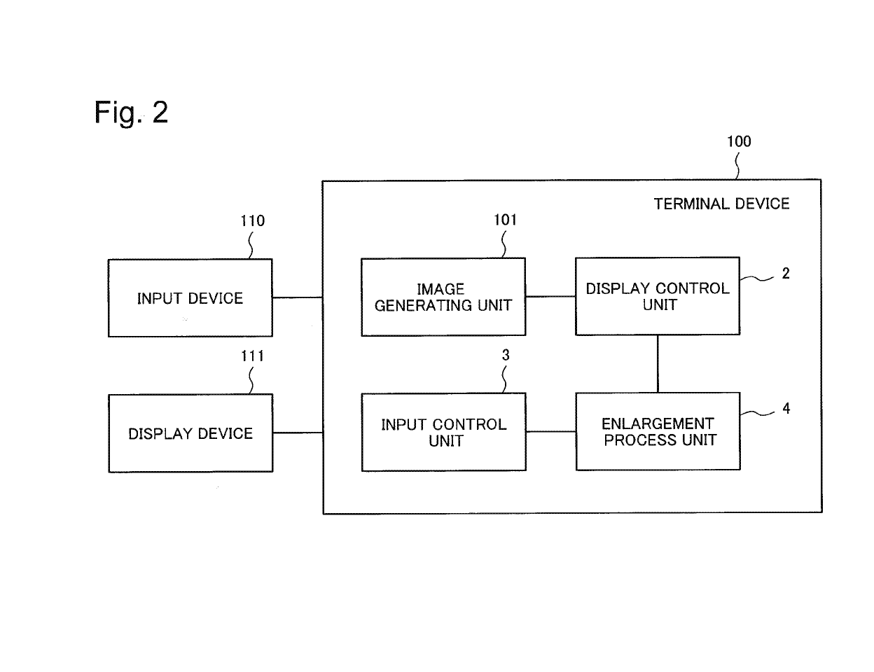

The configuration of the present exemplary embodiment is described referring to FIG. 2. FIG. 2 is a block diagram illustrating a configuration of a terminal device 100, and the input device 110 and a display device 111 connected to the terminal device 100, which is an example of the configuration of the second exemplary embodiment of the invention.

Referring to FIG. 2, the present exemplary embodiment is constituted of the terminal device 100, the input device 110, and the display device 111.

The terminal device 100 may be constituted of a general computer (information processing device) operated by controlling a computer program (software program) to be executed with use of a CPU (not illustrated). Alternatively, the respective units of the terminal device 100 may be constituted of a dedicated hardware device or a logic circuit. A hardware configuration example in which the terminal device 100 is implemented by a computer is described later referring to FIG. 18.

The terminal device 100 includes the image generating unit 101, a display control unit 2, an input control unit 3, and an enlargement process unit 4.

The image generating unit 101 is capable of adding, modifying, or deleting an object on a screen of the display device 111 in response to a user's operation of the input device 110. Specifically, in the present exemplary embodiment, the image generating unit 101 generates the drawing data 5 in the first exemplary embodiment. The image generating unit 101 outputs the generated drawing data 5 to the display control unit 2.

The respective structures and contents of the display control unit 2, the input control unit 3, and the enlargement process unit 4 in the present exemplary embodiment are based on the first exemplary embodiment except for the following points.

In the present exemplary embodiment, the display control unit 2 acquires the drawing data 5 from the image generating unit 101, and displays the acquired drawing data 5 on a screen of the display device 111. Further, the display control unit 2 stores the acquired drawing data 5 in an unillustrated storage device.

In the present exemplary embodiment, the input control unit 3 is capable of allowing the user to input an enlargement instruction 6 (enlargement operation) with use of the input device 110. Further, in the present exemplary embodiment, an example of enlargement ratio information is a numerical value, which represents an enlargement ratio in the unit of percentage %. As well as the first exemplary embodiment, the input control unit 3 outputs enlargement instruction information relating to the enlargement instruction 6 from the user to the enlargement process unit 4.

In the present exemplary embodiment, the enlargement process unit 4 reads the drawing data 5 from the storage device stored in the display control unit 2 for acquiring the drawing data 5. Further, when an enlargement process is executed, the enlargement process unit 4 maintains a positional relationship between objects. An example of the positional relationship between objects is a dispositional relationship between objects, as represented by an upper position, a lower position, a left position, a right position, an upper left position, an upper right position, a lower left position, and a lower right position in the case of a two-dimensional plane such as a screen. In the present exemplary embodiment, for instance, the enlargement process unit 4 maintains a positional relationship between centers of objects (center coordinates) for maintaining the positional relationship between objects.

The respective structures and contents of the display control unit 2, the input control unit 3, and the enlargement process unit 4 in the present exemplary embodiment are the same as those in the first exemplary embodiment except for the above points, and therefore, repeated detailed description thereof is omitted.

The input device 110 is an input device communicatively connected to the terminal device 100. The input device 110 is capable of allowing the user to input such as an object input operation, and an enlargement operation with respect to the terminal device 100. The input device 110 is implemented by a pointing device such as a mouse, a keyboard, a touch panel, or the like.

The display device 111 is a display device communicatively connected to the terminal device 100. The display device 111 is capable of presenting (displaying) drawing data to be output from the display control unit 2 to the user. The display device 111 is implemented by a display device including a screen, a projector for projecting an image on an external screen or the like, a touch panel, or the like.

Next, the procedure to be performed by the present exemplary embodiment having the above configuration is described in detail.

First of all, the premise in the following description is described.

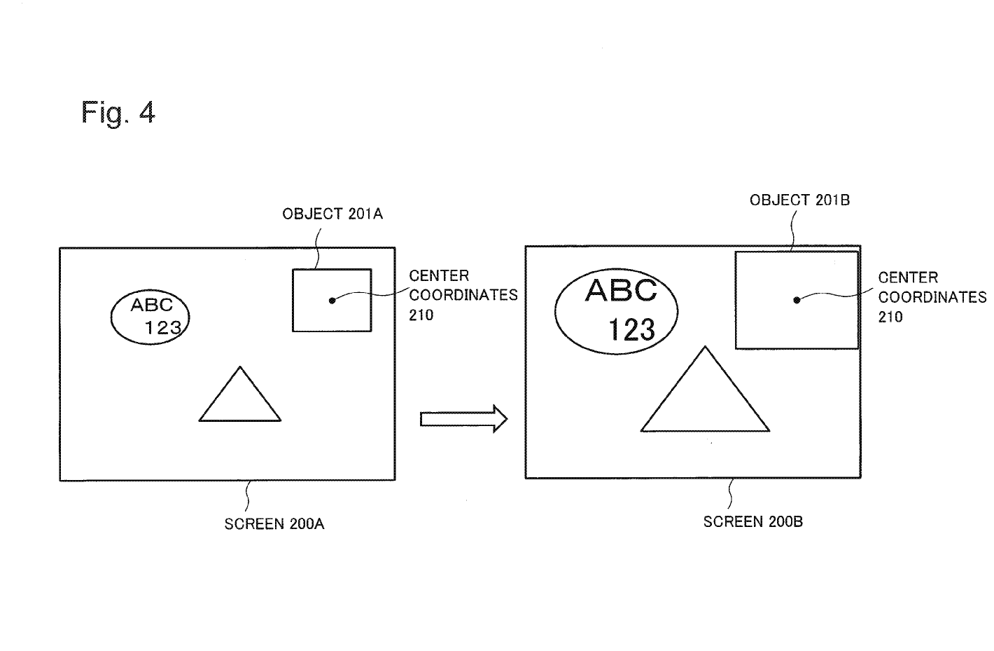

It is assumed that the image generating unit 101 generates the drawing data 5 in response to a user's operation of the input device 110, and inputs the drawing data 5 to the display control unit 2. It is assumed that the display control unit 2 is in a state that a screen as represented by a screen 200A illustrated in FIG. 4 is displayed with use of the display device 111. FIG. 4 is a diagram illustrating an example of a screen including objects in the second exemplary embodiment. FIG. 4 includes the screen 200A representing a screen before enlargement, and a screen 200B representing a screen after enlargement. Three objects including an object 201A of a rectangular shape are disposed on the screen 200A. Three objects after enlargement, including an object 201B which is an enlargement result of the object 201A of a rectangular shape, are disposed on the screen 200B.

Further, in the present exemplary embodiment, object information included in the drawing data 5 includes, for instance, shape information representing the shape of an object, disposition information representing a display position of an object (coordinates on a screen), and size information representing the size of an object.

Further, in the present exemplary embodiment, an example of the input device 110 is a mouse. Further, in the present exemplary embodiment, the display device 111 is a display including a screen.

The enlargement procedure described in the following starts when the user performs an enlargement operation with use of a mouse (input device 110), referring to a screen as illustrated by the screen 200A in FIG. 4, which is displayed on a display (display device 111).

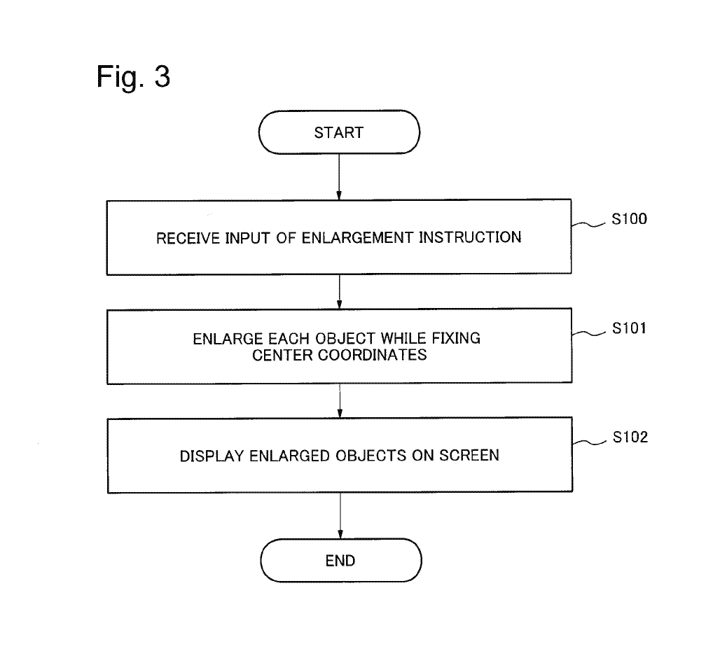

In the following, a detail procedure in the above premise is described referring to FIG. 3. FIG. 3 is a flowchart illustrating an enlargement procedure to be performed by the terminal device 100 in the second exemplary embodiment.

First of all, the input control unit 3 receives an input of the enlargement instruction 6 in response to a user's enlargement operation with use of the input device 110 (Step S100). Specifically, the user clicks (selects) any one of the objects included in the screen 200A in FIG. 4, and drags the object until an intended size is obtained, with use of a mouse (input device 110), and thereafter, releases the button of the mouse, whereby the enlargement instruction 6 is input. When the enlargement instruction 6 is input, the input control unit 3 calculates an enlargement ratio, based on the moving distance of the mouse by the drag operation. As a concrete example, it is assumed that the user clicks the object 201A on the screen 200A, and drags the object 201A until the size of the object 201A is equal to the size of an object 201B on the screen 200B. For instance, the input control unit 3 calculates the enlargement ratio to be “a”, based on the size of the object 201A and based on the moving distance of the mouse. The input control unit 3 outputs, to the enlargement process unit 4, enlargement instruction information including the value “a”, which is the enlargement ratio information.

Next, the enlargement process unit 4 enlarges each of the objects included in the drawing data 5, based on the enlargement instruction information received from the input control unit 3, while fixing the center coordinates of each of the objects (hereinafter, this process is called as “an enlargement process” (Step S101). Specifically, the enlargement process unit 4 acquires the drawing data 5 associated with the screen 200A in FIG. 4 from the display control unit 2. The enlargement process unit 4 enlarges each of the three objects included in the screen 200A by “a”, based on the enlargement ratio information included in the enlargement instruction information, while fixing the center coordinates of each of the objects. Specifically, the enlargement process unit 4 disposes the object 201B, whose size is enlarged by “a” relative to the size of the object 201A with respect to center coordinates 210 in accordance with the enlargement ratio information with respect to the same center coordinates 210. The enlargement process unit 4 executes the above enlargement process with respect to the other two objects included in the screen 200A in the same manner as described above. The result of enlargement process is as illustrated by the screen 200B in FIG. 4.

Specifically, the enlargement process unit 4 equally enlarges the objects included in the screen 200A with the same enlargement ratio. Further, each of the objects is enlarged in a state that the center coordinates of each of the objects before enlargement are maintained. Therefore, the objects included in the screen 200A before enlargement are also included in the screen 200B after enlargement. The enlargement process unit 4 outputs, to the display control unit 2, enlarged drawing data 5 (enlarged drawing data) including object information relating to the enlarged three objects, as a result of enlargement process.

In the present exemplary embodiment, the enlargement process unit 4 executes the enlargement process while fixing the center coordinates, as an example of the method for maintaining a positional relationship between centers of objects. The center coordinates may not be necessarily fixed. Specifically, the enlargement process unit 4 may displace the centers of objects for utilizing a margin, as long as the positional relationship between centers of objects is maintained.

Lastly, the display control unit 2 displays the enlarged drawing data transferred from the enlargement process unit 4 on the display device 111 (Step S102). Specifically, the display device 111 displays a screen including enlarged three objects, as illustrated by the screen 200B.

In this way, the terminal device 100 in the present exemplary embodiment is capable of enlarging and displaying each of the objects, while displaying the three objects displayed on a screen before enlargement, on a screen after enlargement.

As described above, the present exemplary embodiment has an advantage of maintaining a positional relationship between objects before enlargement, after enlargement, in addition to the same advantages as described in the first exemplary embodiment. The positional relationship between objects is a dispositional relationship between objects, as represented by an upper position, a lower position, a left position, a right position, an upper left position, an upper right position, a lower left position, and a lower right position in the case of a two-dimensional plane such as a screen. The enlargement method in the present exemplary embodiment has a feature such that a positional relationship between objects is maintained. Therefore, the present exemplary embodiment is applicable to a whiteboard function, in which the positional relationship between objects has an important significance.

The above advantage is obtained because each of the objects is enlarged, while maintaining the positional relationship between centers of the objects. Further, the above advantage is obtained because the enlargement process unit 4 enlarges each of the objects, based on the same enlargement ratio.

### Third Exemplary Embodiment

In this section, a third exemplary embodiment based on the first and second exemplary embodiments is described. In the following, the features of the third exemplary embodiment are mainly described. Further, the constituent elements in the third exemplary embodiment including the same configuration as in the first or second exemplary embodiment are indicated with the same reference numerals as the reference numerals in the first or second exemplary embodiment, and repeated detailed description of the constituent elements in the third exemplary embodiment is omitted.

The present exemplary embodiment is an exemplary embodiment, in which the invention is applied to a whiteboard function (shared whiteboard function), in which a virtual screen (whiteboard) is sharable between terminal devices. Generally, in the shared whiteboard function, it is possible to point out a specific target position to other persons, and to notify the other persons of a target portion to be operated by disposing an image indicating a position (position indication image) such as a mouse cursor, in addition to various objects. In the present exemplary embodiment, “a mouse cursor” (hereinafter, also simply called as “a cursor”) is used as an example of the position indication image.

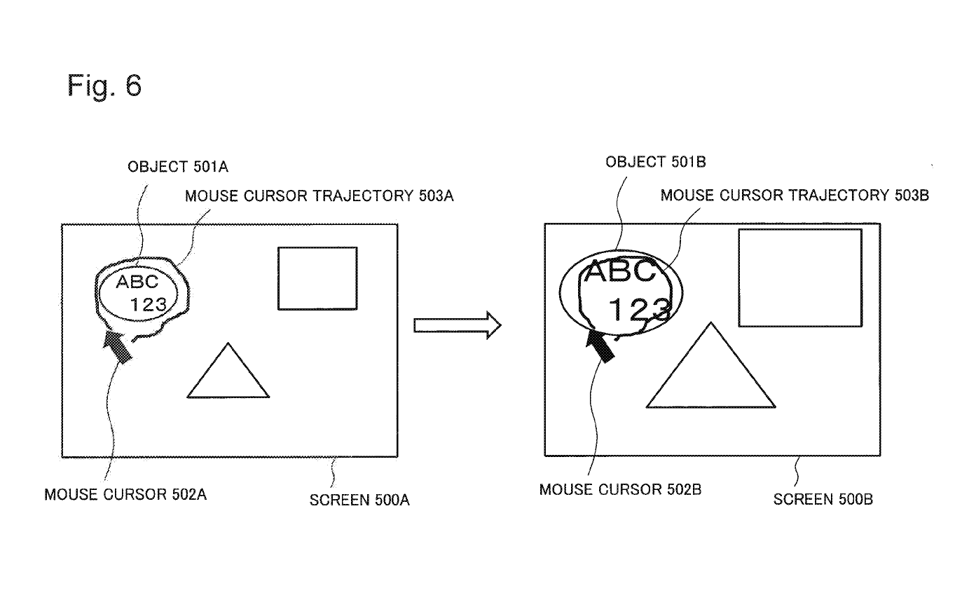

However, when the enlargement method described in the first or second exemplary embodiment is simply applied to the shared whiteboard function of disposing a position indication image, as illustrated in FIG. 6, a positional relationship between the position indication image and an object after enlargement may be deviated. FIG. 6 is an image diagram for representing the problem relating to the positional relationship between an image indicating a position (position indication image), and an object after enlargement in the shared whiteboard function. Referring to FIG. 6, a screen 500A, as an example of a shared whiteboard screen includes an object 501A of an oval shape, a mouse cursor 502A as an example of the position indication image, and a mouse cursor trajectory 503A, which is a trajectory of movement of the mouse cursor 502A. The mouse cursor trajectory 503A surrounds the outside of the object 501A. Further, the mouse cursor 502A is displayed at a lower left position of the object 501A.

On the other hand, a screen 500B is a screen obtained by enlarging the screen 500A by the enlargement method described in the first or second exemplary embodiment. An object 501B, which is a result of enlargement of the object 501A, is displayed on the screen 500B. Further, a mouse cursor 502B, and a mouse cursor trajectory 503B are displayed on the screen 500B at the same coordinate position and with the same size as before enlargement. The mouse cursor trajectory 503B lies on the inside of the object 501B as a result of screen enlargement. Further, the mouse cursor 502B is in contact with the frame of the object 501B. Specifically, the position of the mouse cursor trajectory 503B, and of the mouse cursor 502B with respect to the entirety of the shared whiteboard screen, and with respect to the center coordinates of each of the objects is not changed, but the positional relationship thereof with respect to the whole (outer frame) of the objects after enlargement is changed. In the shared whiteboard function, deviation of a position indication image, which designates a target portion, is a great issue. In the present exemplary embodiment, it is possible to maintain the positional relationship between a position indication image and an object after enlargement.

The present exemplary embodiment is applicable to any function which requires indication of a specific position on a screen or the like, in addition to the whiteboard function.

[Description of Configuration]

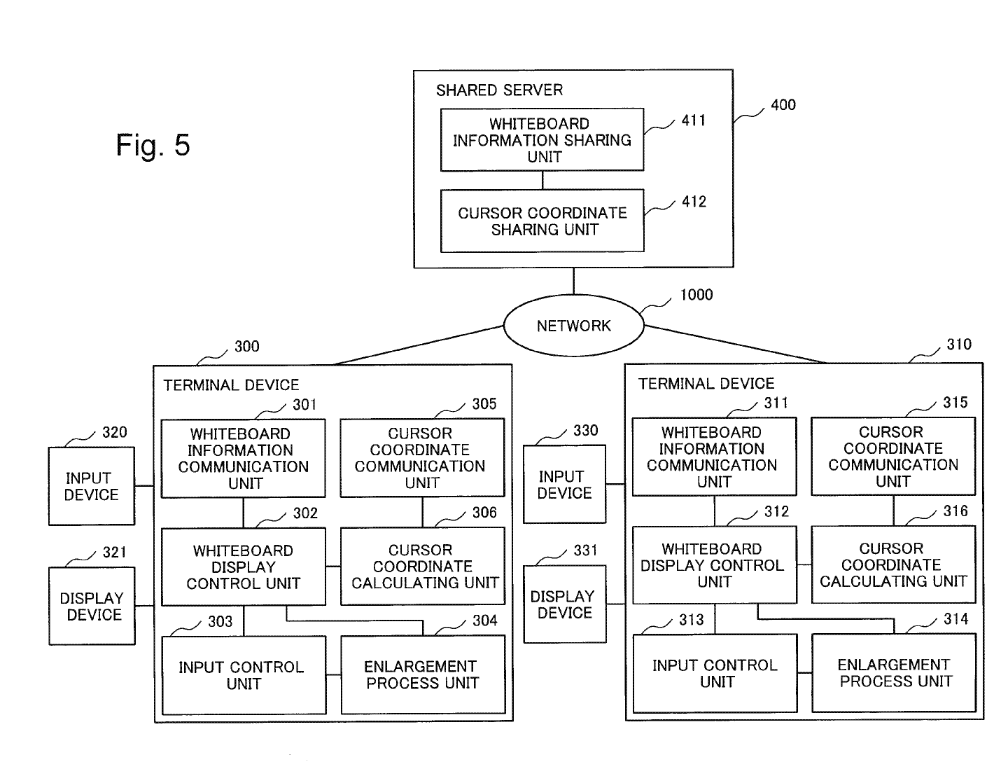

A configuration of the present exemplary embodiment is described referring to FIG. 5. FIG. 5 is a block diagram illustrating a configuration of a shared whiteboard system in the third exemplary embodiment of the invention, and in a modification thereof.

Referring to FIG. 5, the present exemplary embodiment is constituted of a terminal device 300, a terminal device 310, an input device 320, a display device 321, an input device 330, a display device 331, and a shared server 400.

The terminal device 300, the terminal device 310, and the shared server 400 may be constituted of a general computer (information processing device) operated by controlling a computer program (software program) to be executed with use of a CPU (not illustrated). Alternatively, the respective units of the terminal device 300, the terminal device 310, and the shared server 400 may be constituted of a dedicated hardware device or a logic circuit. A hardware configuration example in which the terminal device 300, the terminal device 310, and the shared server 400 are implemented by a computer is described later referring to FIG. 18.

Further, the terminal device 300, the terminal device 310, and the shared server 400 may be communicable with each other via a communication network (hereinafter, simply called as a network) 1000 such as the Internet or an in-house LAN (Local Area Network).

The terminal device 300 includes a whiteboard information communication unit 301, a whiteboard display control unit 302, an input control unit 303, an enlargement process unit 304, a position indication image (cursor) coordinate communication unit 305, and a position indication image (cursor) coordinate calculating unit 306.

The respective structures and contents of the whiteboard information communication unit 301, the whiteboard display control unit 302, the input control unit 303, and the enlargement process unit 304 in the present exemplary embodiment are based on the first or second embodiment except for the following points.

The whiteboard information communication unit 301 is associated with the image generating unit 101 in the second exemplary embodiment. In the present exemplary embodiment, the whiteboard information communication unit 301 receives drawing data 5 from the shared server 400 for acquiring the drawing data 5. The whiteboard information communication unit 301 outputs the acquired drawing data 5 to the whiteboard display control unit 302.

The whiteboard display control unit 302 is associated with the display control unit 2 in the first and second exemplary embodiments. In the present exemplary embodiment, the whiteboard display control unit 302 acquires the drawing data 5 from the whiteboard information communication unit 301, and displays the acquired drawing data 5 on a screen of the display device 321.

The input control unit 303 is associated with the input control unit 3 in the first and second exemplary embodiments. In the present exemplary embodiment, the input control unit 303 is capable of allowing the user to input an enlargement instruction 6 with use of the input device 320. Further, the input control unit 303 outputs enlargement instruction information relating to the enlargement instruction 6 input from the user to the enlargement process unit 304.

The enlargement process unit 304 is associated with the enlargement process unit 4 in the first and second exemplary embodiments. The enlargement process unit 304 executes an enlargement process of enlarging each of the objects included in the drawing data 5 acquired from the whiteboard display control unit 302, based on the enlargement instruction information received from the input control unit 303. The enlargement process unit 304, however, executes a new process before and after the enlargement process to be executed by the enlargement process unit 4 in the first and second exemplary embodiments. Specifically, the enlargement process unit 304 divides a screen into a plurality of areas by sandwiching each of the objects by two line segments in parallel to each of coordinate axes on the screen before the enlargement process is executed. Further, the enlargement process unit 304 evaluates a positional relationship between areas including an object after the enlargement process is executed for controlling enlargement in such a manner that a result of enlargement by the enlargement process lies in a range of maintaining a positional relationship between areas.

The input device 320 is associated with the input device 110 in the second exemplary embodiment. The input device 320 is capable of allowing the user to input such as an object input operation, cursor movement, and an enlargement operation with respect to the terminal device 300.

The display device 321 is associated with the display device 111 in the second exemplary embodiment. The display device 321 is capable of presenting (displaying) drawing data to be output from the whiteboard display control unit 320 to the user.

As described above, the respective structures and contents of the whiteboard information communication unit 301, the whiteboard display control unit 302, the input control unit 303, the enlargement process unit 304, the input device 320, and the display device 321 in the present exemplary embodiment are the same as those in the first or second exemplary embodiment except for the above points, and therefore, repeated detailed description thereof is omitted.

The cursor coordinate calculating unit 306 converts (calculates) actual coordinates of a cursor on a screen into in-area coordinates in an area in which the cursor is displayed, based on information relating to the screen, which has been acquired from the whiteboard display control unit 302, when a transmission operation is performed. The cursor coordinate calculating unit 306 outputs, to the cursor coordinate communication unit 305, in-area coordinate information representing the calculated in-area coordinates of a cursor.

Further, the cursor coordinate calculating unit 306 converts (calculates) into actual coordinates on a screen, based on the in-area coordinate information received from the cursor coordinate communication unit 305 when a receiving operation is performed. The cursor coordinate calculating unit 306 outputs, to the whiteboard display control unit 302, actual coordinate information representing the calculated actual coordinates of a cursor. The whiteboard display control unit 302 displays a cursor on a screen of the display device 321, based on the received actual coordinate information.

In the present exemplary embodiment, the cursor coordinate calculating unit 306 is operable to perform both of a transmission operation and a receiving operation. Alternatively, the cursor coordinate calculating unit 306 may be operable to perform one of the transmission operation and the receiving operation.

The cursor coordinate communication unit 305 transmits, to the shared server 400, the in-area coordinate information of a cursor, which has been received from the cursor coordinate calculating unit 306, when a transmission operation is performed.

Further, the cursor coordinate communication unit 305 receives in-area coordinate information of a cursor in another terminal device from the shared server 400, and outputs the received in-area coordinate information to the cursor coordinate calculating unit 306 when a receiving operation is performed.

In the present exemplary embodiment, the cursor coordinate communication unit 305 is operable to perform both of a transmission operation and a receiving operation. Alternatively, the cursor coordinate communication unit 305 may be operable to perform one of the transmission operation and the receiving operation. Further alternatively, the cursor coordinate communication unit 305 and the whiteboard information communication unit 301 may be individual communication units or may be one communication unit.

The terminal device 310 has the same configuration as the configuration of the terminal device 300. Specifically, the terminal device 310 includes a whiteboard information communication unit 311, a whiteboard display control unit 312, an input control unit 313, an enlargement process unit 314, a position indication image (cursor) coordinate communication unit 315, and a position indication image (cursor) coordinate calculating unit 316. The functions and configurations of the respective units in the terminal device 310 are the same as those of the units having the same reference numerals in the terminal device 300. Therefore, detailed description of the respective units in the terminal device 310 is omitted. Further, the terminal device 310 is communicatively connected to an input device 330 and to a display device 331. The function and configuration of the input device 330 are the same as those of the input device 320. Therefore, detailed description of the input device 330 is omitted. Further, the function and configuration of the display device 331 are the same as those of the display device 321. Therefore, detailed description of the display device 331 is omitted.

The shared server 400 includes a whiteboard information sharing unit 411 and a position indication image (cursor) coordinate sharing unit 412.

The whiteboard information sharing unit 411 transmits the drawing data 5 to the whiteboard information communication unit 301 in the terminal device 300, and to the whiteboard information communication unit 311 in the terminal device 310. The whiteboard information sharing unit 411 may receive the drawing data 5 from an unillustrated external device, the terminal device 310, the terminal device 311, or the like via a network, and record the received drawing data 5 in a storage device for acquiring the drawing data 5. Alternatively, the whiteboard information sharing unit 411 may read the drawing data 5 from an unillustrated storage device via an internal bus for acquiring the drawing data 5. The whiteboard information sharing unit 411 may hold the acquired drawing data 5 in an unillustrated storage device or the like.

The cursor coordinate sharing unit 412 is capable of receiving in-area coordinate information of a cursor from the cursor coordinate communication unit 305 in the terminal device 300, and from the cursor coordinate communication unit 315 in the terminal device 310. The cursor coordinate sharing unit 412 transmits the received in-area coordinate information of a cursor to another terminal device. Specifically, the cursor coordinate sharing unit 412 transmits coordinate information received from the terminal device 300 to the terminal device 310. Contrary to the above, the cursor coordinate sharing unit 412 transmits the coordinate information received from the terminal device 310 to the terminal device 300.

In the present exemplary embodiment, the terminal device is constituted of two devices. The number of terminal devices capable of implementing the present exemplary embodiment is not limited to the above. The respective units in the shared server 400 are capable of executing the above function with respect to three or more terminal devices.

Next, procedures of the present exemplary embodiment provided with the above configuration are described in detail. In the present exemplary embodiment, there are two procedures i.e. an enlargement procedure (procedure of enlargement process) of a whiteboard (screen), and a procedure (shared display function of position indication image) of implementing a shared display function of a position indication image (cursor) on the enlarged screen.

[Description on Procedure of Enlargement Process]

In this section, an enlargement procedure in the terminal device 300 is described as a concrete example. The enlargement procedure in the present exemplary embodiment is based on the enlargement procedure in the second exemplary embodiment. Therefore, repeated detailed description on the same procedure as in the second exemplary embodiment is omitted in the following description.

First of all, the premise in the following description is described.

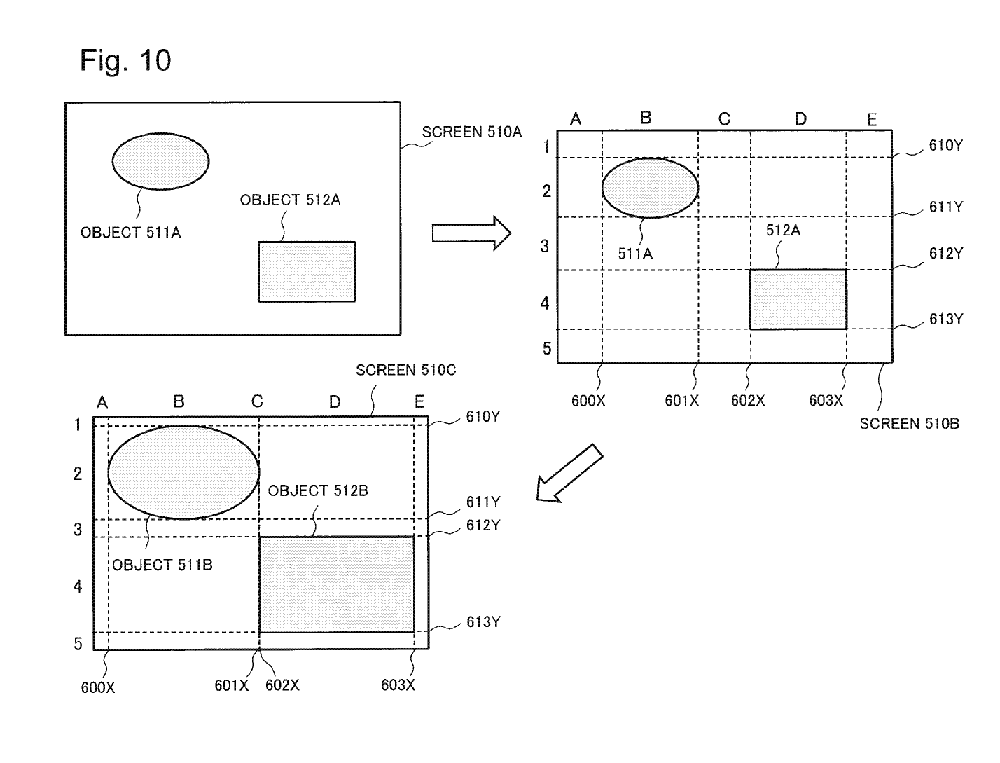

It is assumed that in the terminal device 300, the whiteboard information communication unit 301 receives in advance the drawing data 5 from the whiteboard information sharing unit 411 in the shared server 400, and outputs the received drawing data 5 to the whiteboard display control unit 302. It is assumed that the whiteboard display control unit 302 is in a state that a screen as illustrated by a screen 510A in FIG. 10 is displayed with use of the display device 321. FIG. 10 is a diagram illustrating an example of a screen image for representing an enlargement procedure in the third exemplary embodiment. FIG. 10 includes the screen 510A representing a screen before enlargement, a screen 510B representing an internal screen image subjected to area dividing in the enlargement process, and a screen 510C representing a screen after enlargement. Two objects i.e. an object 511A of an oval shape and an object 512A of a rectangular shape are disposed on the screen 510A. Details of the screen 510B and of the screen 510C are described later.

Further, in the present exemplary embodiment, an example of the input device 320 is a mouse. Further, in the present exemplary embodiment, the display device 321 is a display including a screen.

The enlargement procedure described in the following starts when the user performs an enlargement operation with use of a mouse (input device 320), referring to a screen as illustrated by the screen 510A in FIG. 10, which is displayed on a display (display device 321).

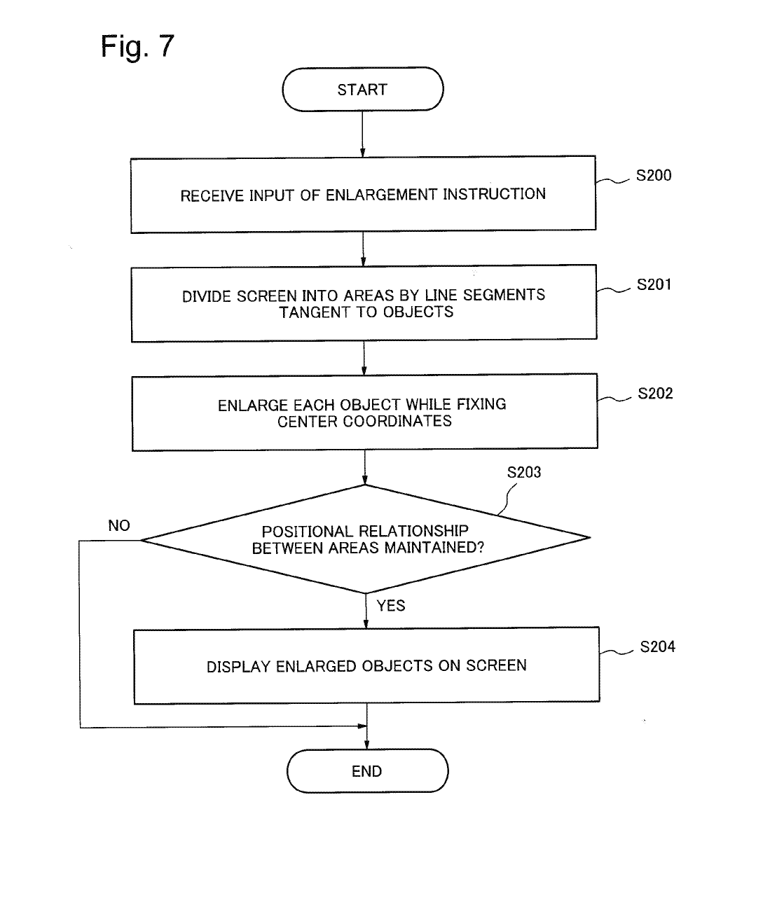

In the following, a detail procedure in the above premise is described referring to FIG. 7 and FIG. 10. FIG. 7 is a flowchart illustrating an enlargement procedure to be performed by the terminal device 300 in the third exemplary embodiment.

First of all, the input control unit 303 receives an input of the enlargement instruction 6 in response to a user's enlargement operation with use of the input device 320 (Step S200). The procedure of the input control unit 303 in the present step is the same as the procedure of the input control unit 3 in Step S100 in the second exemplary embodiment. Specifically, the input control unit 303 calculates the enlargement ratio to be “a”, and outputs, to the enlargement process unit 304, enlargement instruction information including enlargement ratio information representing the calculated enlargement ratio. Repeated detailed description of the same procedure as in the second exemplary embodiment is omitted.

Subsequently, the enlargement process unit 304 sandwiches each of the objects included in a screen by two line segments in parallel to each of coordinate axes. By performing the above procedure, the enlargement process unit 304 divides the screen into a plurality of areas (Step S201). In the following, the procedure of the enlargement process unit 304 in Step S201 is called as “area dividing”. In the case of the present exemplary embodiment, the coordinate axes include two axes i.e. a horizontal axis corresponding to a horizontal direction on a screen, and a vertical axis corresponding to a vertical direction on the screen. When the display device 321 is capable of displaying a three-dimensional stereoscopic image, the coordinate axes include three axes.

In the following, a concrete example of a procedure to be performed by the respective units when area dividing is performed is described referring to the screen 510B in FIG. 10.

First of all, the enlargement process unit 304 disposes a line segment 600X and a line segment 601X in parallel to the vertical axis so that the line segments 600X and 601X are tangent to the object 511A. Subsequently, the enlargement process unit 304 disposes a line segment 610Y and a line segment 611Y in parallel to the horizontal axis so that the line segments 610Y and 611Y are tangent to the object 511A. When the above procedures are performed, the end points of each of the line segments 600X, 601X, 610Y, and 611Y lie on one end and the other end of a screen. Likewise, the enlargement process unit 403 disposes four line segments with respect to the object 512A. Specifically, the enlargement process unit 403 disposes a line segment 602X and a line segment 603X in parallel to the vertical axis, and disposes a line segment 612Y and a line segment 613Y in parallel to the horizontal axis so that the line segments 602X, 603X, 612Y, and 613Y are tangent to the object 512A. In the present exemplary embodiment, areas on a screen divided by the eight line segments disposed as described above, and by the frame of the screen are called as “areas”. In this way, the enlargement process unit 304 divides a screen into twenty-five areas in the concrete example illustrated by the screen 510B.

Subsequently, the enlargement process unit 304 enlarges each of the objects included in the drawing data 5, based on the enlargement instruction information received from the input control unit 303, while fixing the center coordinates of each of the objects (Step S202). The procedure of the enlargement process unit 304 in the present step is the same as the procedure of the enlargement process unit 4 in Step S101 in the second exemplary embodiment except that the line segments disposed tangent to the objects are moved, as the objects are enlarged. Specifically, the enlargement process unit 304 enlarges each of the object 511A and an object 512A by “a”, based on the enlargement ratio information included in the enlargement instruction information, while fixing the center coordinates of each of the object 511A and the object 512A. The enlargement process unit 304 moves the line segments 600X, 601X, 602X, 603X, 610Y, 611Y, 612Y, and 613Y to such positions that the line segments 600X, 601X, 602X, 603X, 610Y, 611Y, 612Y, and 613Y are tangent to the enlarged objects, as the objects are enlarged. The result of enlargement process is as illustrated by the screen 510C. The enlarged object 511A is illustrated as an object 511B on the screen 510C. Further, the enlarged object 512A is illustrated as the object 512B on the screen 510C. Repeated detailed description of the same procedure as in the second exemplary embodiment is omitted.

Subsequently, the enlargement process unit 304 determines whether the positional relationship between areas including each of the objects is maintained, as a result of enlargement process (Step S203). The positional relationship between areas is, for instance, a dispositional relationship between areas in the case of a two-dimensional plane such as a screen in the present exemplary embodiment. Specifically, the dispositional relationship between areas is a relationship representing a directional position of an area with respect to another area, as represented by an upper position, a lower position, a left position, a right position, an upper left position, an upper right position, a lower left position, and a lower right position. More specifically, the enlargement process unit 304 recognizes a positional relationship of an area including the object 512A with respect to an area including the object 511A on the screen 510B before enlargement as “a lower right position”. The enlargement process unit 304 also recognizes a positional relationship of an area including the object 512B with respect to an area including the object 511B on the screen 510C after enlargement as “a lower right position”. The enlargement process unit 304 determines that the positional relationship between the area including the object 511A (511B), and the area including the object 512A (512B) is maintained, in view of that the positional relationship between areas is the same between before enlargement process and after enlargement process.

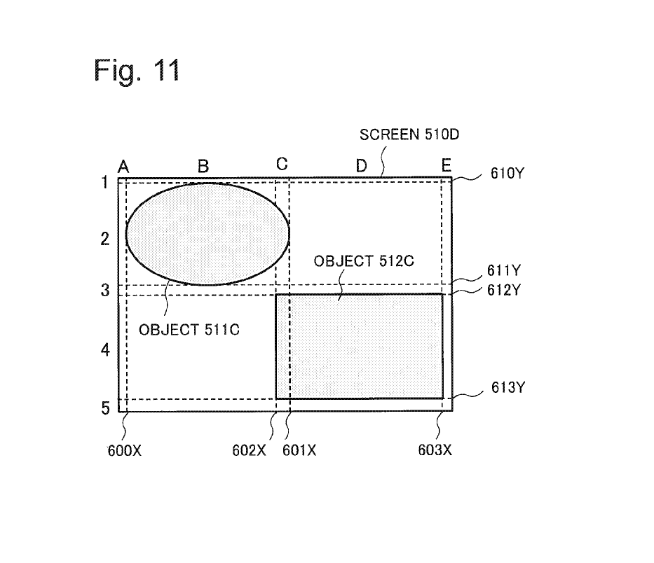

On the other hand, for instance, when the result of enlargement process is represented by a screen 510D illustrated in FIG. 11, the enlargement process unit 304 recognizes the positional relationship of an object 512C with respect to an area including an object 511C on the screen 510D as “a lower right position, and a lower position”. FIG. 11 is a diagram illustrating a screen image for representing an enlargement procedure in the third exemplary embodiment. The object 511C on the screen 510D is an object obtained by enlarging the object 511B on the screen 510C. Further, the object 512C on the screen 510D is an object obtained by enlarging the object 512B on the screen 510C. In this case, the enlargement process unit 304 determines that the positional relationship between areas is not maintained, because the positional relationship is changed from “the lower right position to “the lower right position, and the lower position” as a result of enlargement process.

Various methods other than the above may be suggested as a method for determining whether the positional relationship between areas including each of the objects is maintained by the enlargement process unit 304. For instance, the enlargement process unit 304 may judge that the positional relationship between areas is maintained, based on the order of coordinates at which line segments are disposed along a coordinate axis. Specifically, the enlargement process unit 304 recognizes “line segments 600X, 601X, 602X, and 603X” in the order of coordinates on the screen 510B and on the screen 510C in FIG. 10. On the other hand, the enlargement process unit 304 recognizes “line segments 600X, 602X, 601X, and 603X” on the screen 510D in FIG. 11 after enlargement process. The enlargement process unit 304 may determine that the positional relationship is not maintained, in view of that the order of the line segment 601X and the line segment 602X is reversed, as a result of comparison of the order of coordinates of line segments between before enlargement and after enlargement.

The method for determining whether the positional relationship between areas including each of the objects is maintained by the enlargement process unit 304 may be such that it is determined whether line segments (601X and 602X, or 611Y and 612Y) adjacent to the respective objects 511A and 512A overlap each other when the objects 511A and 512A on the screen 510B are respectively enlarged. For instance, the enlargement process unit 304 recognizes that the line segments 601X and 602X overlap each other on the screen 510C in FIG. 10 as a result of enlargement of each of the objects. By the recognition, the enlargement process unit 304 determines that the positional relationship between areas is not maintained any longer.

Further, as another example, it is possible to determine that the positional relationship between areas is not maintained any longer at a position where a marginal area (excluding an object) disappears by focusing on an area, in place of focusing on overlapping of line segments.

When it is determined that the positional relationship between areas including each of the objects is maintained, the enlargement process unit 304 outputs, to the whiteboard display control unit 302, enlarged drawing data 5 (enlarged drawing data) including object information after enlargement process. On the other hand, when it is determined that the positional relationship between areas including each of the objects is not maintained, the enlargement process unit 304 discards the result of enlargement process (or stops the enlargement process), whereby the enlargement process is ended.

Lastly, the whiteboard display control unit 302 displays the enlarged drawing data transferred from the enlargement process unit 304 on the display device 321 (Step S204). Specifically, the display device 321 displays a screen as illustrated by the screen 510C. The whiteboard display control unit 302 may not display the line segments 600X, 601X, 602X, 603X, 610Y, 611Y, 612Y, and 613Y.

By performing the above enlargement procedure, the terminal device 300 displays the screen 510C, on which the objects on the screen 510A are enlarged. The terminal device 310 may be also capable of performing the enlargement procedure in the same manner as described above.

When the user performs an enlargement operation by dragging with use of a mouse, the terminal device 300 may repeat the above enlargement procedure stepwise, as the mouse is moved. Specifically, the terminal device 300 gradually enlarges each of the objects, as the user drags the objects with use of the mouse, and stops the enlargement when it is determined that the positional relationship between areas including each of the objects is not maintained any longer.

As described above, the present exemplary embodiment has an advantage of individually setting a screen enlargement ratio between terminal devices that share a screen by a shared whiteboard function, in addition to the same advantages as described in the first and second exemplary embodiments.

The above advantage is obtained because an enlargement process in accordance with an enlargement ratio designated for each of the terminal devices is executed, based on the drawing data 5 provided from the shared server 400. Specifically, it is not necessary for a terminal device to transmit an enlargement ratio to the shared server 400. Therefore, it can be said that the shared whiteboard system in the present exemplary embodiment is capable of implementing enlargement ratios different from each other between terminal devices.

[Description on Shared Display Function of Position Indication Image]

In this section, a procedure of implementing a function (shared display function) of sharing display of a position indication image on a screen enlarged by the aforementioned enlargement procedure is described. In the present exemplary embodiment, a concrete example of the position indication image is a mouse cursor (hereinafter, also simply called as “a cursor”). The shared display function is implemented by causing a terminal device to perform a transmission operation of transmitting the coordinates of a cursor, and causing another terminal device to perform a receiving operation of receiving the transmitted coordinates of the cursor. In the following concrete example, a procedure of implementing the shared display function of a mouse cursor between terminal devices whose screen enlargement ratios differ from each other is described.

The position indication image may not be always displayed on a screen, when one or both of the input device 320 and the input device 330 is a device capable of allowing the user to input a position by finger touch, such as a touch panel. Alternatively, the position indication image may be displayed at any position on a screen, as an image movable by the user, as necessary.

In the following, it is assumed that the terminal device 310 shares display of a mouse cursor of the terminal device 300 on a screen of the terminal device 310. Specifically, the terminal device 300 performs a transmission operation, and the terminal device 310 performs a receiving operation.

Further, in the present exemplary embodiment, it is assumed that the shared display function of a cursor has already started in response to a user's instruction or the like. Further, it is assumed that the shared display function of a cursor is allowed to be finished in response to a user's instruction or the like. Instruction to start or finish the shared display function of a cursor may be performed in response to a user's clicking a button prepared on a screen of the terminal device 300 with use of a mouse.

Further, it is assumed that the mouse cursor is always displayed on the terminal device 300, irrespective of an on/off state of the shared display function.

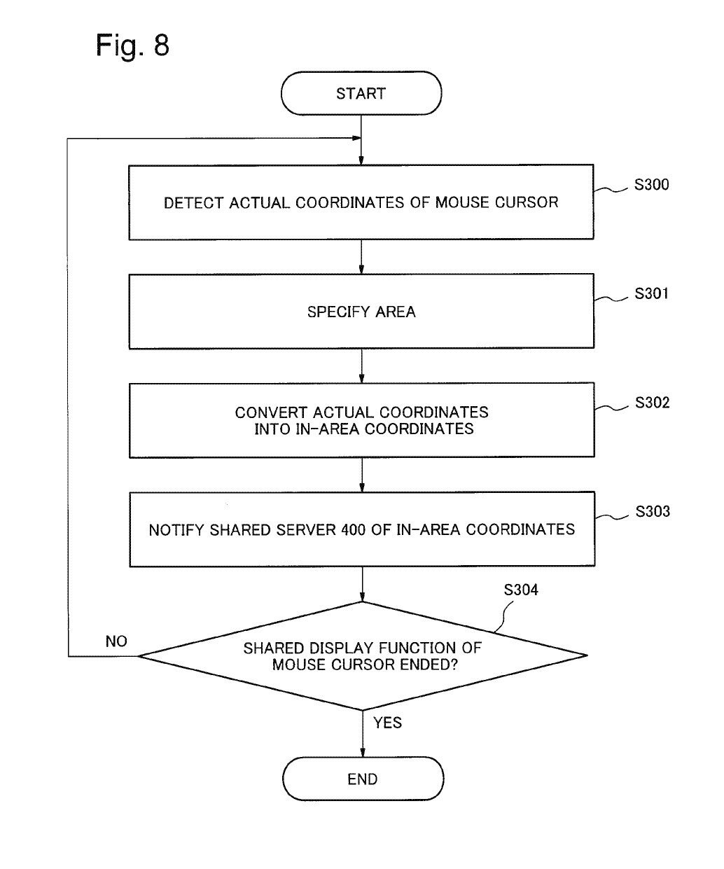

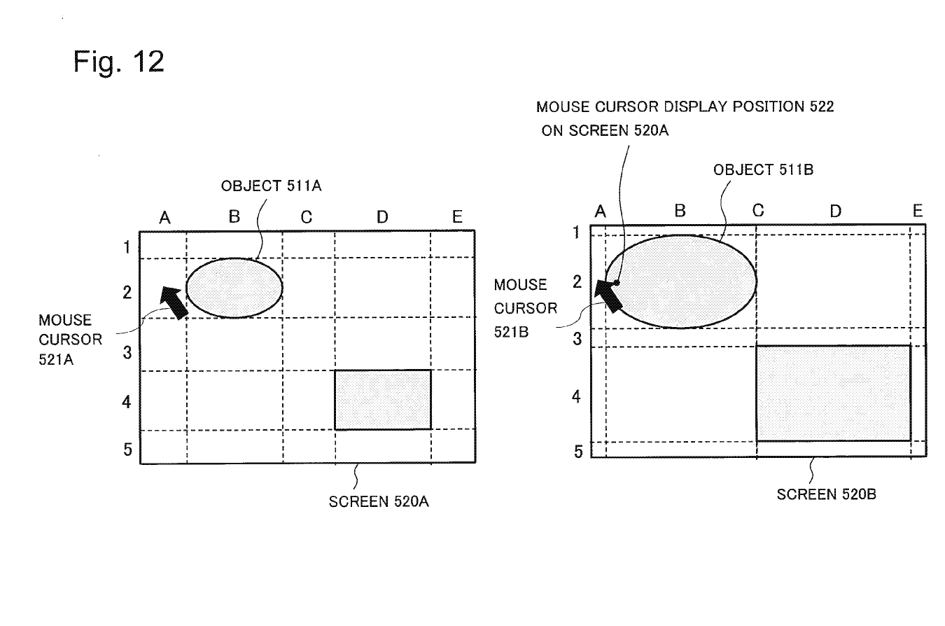

In the following, an operation (transmission operation) to be performed by the terminal device 300 is described referring to FIG. 8 and FIG. 12. FIG. 8 is a flowchart illustrating a transmission operation in the shared display function of a position indication image to be performed by the terminal device 300 in the third exemplary embodiment. FIG. 12 is a diagram illustrating an example of a screen on a transmission side and on a receiving side when the coordinates of a position indication image are shared in the third exemplary embodiment.

First of all, the user instructs to start the shared display function of a mouse cursor. Subsequently, the cursor coordinate calculating unit 306 detects actual coordinates of the mouse cursor, based on information relating to a screen, which has been acquired from the whiteboard display control unit 302 (Step S300). The actual coordinates are coordinates of a mouse cursor on an actual screen displayed on the display device 321. For instance, when a screen 520A before enlargement (see FIG. 12) is displayed on the display device 321, the cursor coordinate calculating unit 306 acquires, from the whiteboard display control unit 302, mouse cursor information including actual coordinate information representing the actual coordinates of a mouse cursor 521A. When the above procedure is performed, the actual coordinates of the mouse cursor 521A acquired by the cursor coordinate calculating unit 306 are assumed to be (x1, y1). The coordinates are represented as (a coordinate on a horizontal axis, a coordinate on a vertical axis).

Subsequently, the cursor coordinate calculating unit 306 specifies an area in which the mouse cursor is disposed, based on the actual coordinates of the mouse cursor (Step S301). Specifically, the cursor coordinate calculating unit 306 performs the same process as the area dividing which has been performed by the enlargement process unit 304 in Step S201 in the enlargement process for acquiring an area division state. Alternatively, the cursor coordinate calculating unit 306 may read a result of area dividing recorded, by the enlargement process unit 304, in an unillustrated recording device for acquiring an area division state.

Subsequently, the cursor coordinate calculating unit 306 specifies the area number, which is information for identifying the area including the actual coordinates of the mouse cursor 521A. For instance, the cursor coordinate calculating unit 306 labels the areas divided by line segments in a horizontal direction on the screen 520A as A, B, C, D, and E from the left side. Further, the cursor coordinate calculating unit 306 labels the areas divided by line segments in a vertical direction on the screen 520A as 1, 2, 3, 4, and 5 from the upper side. The cursor coordinate calculating unit 306 specifies the area number of the area including the actual coordinates of the mouse cursor 521A as the “area (A, 2)”. Another example of an indication of the area number is the area number of the area including the object 511A, i.e., the “area (B, 2)”.

Subsequently, the cursor coordinate calculating unit 306 converts the actual coordinates of the mouse cursor into in-area coordinates, which are the coordinates using an area as a reference (Step S302). The in-area coordinates are information obtained by combining relative coordinates representing the position of a mouse cursor in a specified area, and the area number. The relative coordinates may be represented as coordinates of a mouse cursor, assuming that the length of each side of the area is calculated to be 1. In this case, assuming that the upper left corner of an area is represented as “(0, 0)”, the lower right corner of the area is represented as “(1, 1)”. Specifically, when the mouse cursor 521A is located at the middle of the area (A, 2), the cursor coordinate calculating unit 306 converts the actual coordinates “(x1, y1)” of the mouse cursor 521A into in-area coordinates “area (A, 2), relative coordinates (0.5, 0.5)”. The cursor coordinate calculating unit 306 outputs, to the cursor coordinate communication unit 305, in-area coordinate information representing the calculated in-area coordinates of a cursor. The aforementioned relative coordinate representation method is an example. Relative coordinates may be represented by another method.

Subsequently, the cursor coordinate communication unit 305 transmits, to the shared server 400, the in-area coordinate information of a cursor, which has been received from the cursor coordinate calculating unit 306 (Step S303). Specifically, the cursor coordinate communication unit 305 transmits, to the shared server 400, in-area coordinate information including the information “area (A, 2), relative coordinates (0.5, 0.5)”.

When the in-area coordinate information of a cursor is received, the cursor coordinate sharing unit 412 in the shared server 400 distributes the received in-area coordinate information to another terminal device (i.e. the terminal device 310) that is executing the shared display function of the mouse cursor. The receiving operation to be performed by the terminal device 310 which receives distribution is described later.

When the shared display function of the mouse cursor is not ended, the cursor coordinate calculating unit 306 returns to Step S300, and repeats the procedure thereafter at a predetermined time interval or the like (Step S304).

As described above, the terminal device 300 performs a transmission operation in the shared display function of the mouse cursor.

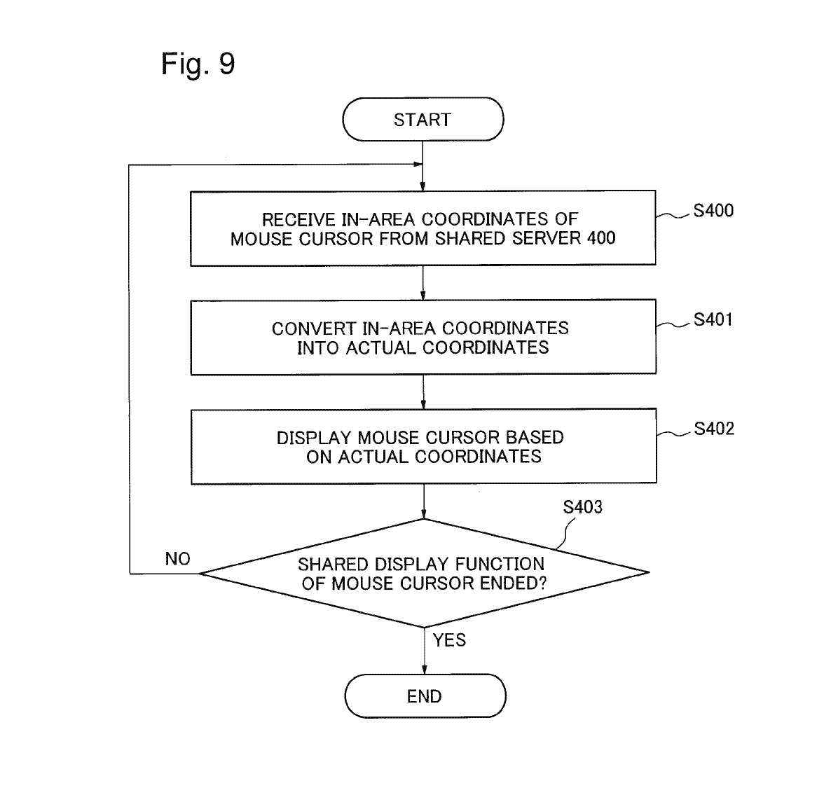

Next, an operation (receiving operation) to be performed by the terminal device 310 is described referring to FIG. 9 and FIG. 12. FIG. 9 is a flowchart illustrating a receiving operation in the shared display function of a position indication image to be performed by the terminal device 310 in the third exemplary embodiment.

It is assumed that the display device 331 in the terminal device 310 displays an enlarged screen as illustrated by the screen 510C (see FIG. 10). Specifically, the screen enlargement ratio differs between the terminal device 300 which does not enlarge a screen, and the terminal device 310.

The following receiving operation starts, after the cursor coordinate sharing unit 412 in the shared server 400 receives the in-area coordinate information of a cursor (Step S303), in response to distribution of the received in-area coordinate information to the terminal device 310 by the cursor coordinate sharing unit 412.

First of all, when the cursor coordinate sharing unit 412 in the shared server 400 distributes the in-area coordinate information of a cursor to the terminal device 310, the cursor coordinate communication unit 315 in the terminal device 310 receives the in-area coordinate information of a cursor (Step S400). It is assumed that the received in-area coordinate information of a cursor includes the information “area (A, 2), relative coordinates (0.5, 0.5)”. The cursor coordinate communication unit 315 outputs the received in-area coordinate information to the cursor coordinate calculating unit 316.

Subsequently, the cursor coordinate calculating unit 316 converts into actual coordinates on a screen, based on the in-area coordinate information received from the cursor coordinate communication unit 315 (Step S401). Specifically, the cursor coordinate calculating unit 316 acquires an area division state in the same manner as the cursor coordinate calculating unit 306 in Step S301. After acquiring a display position on the “area (A, 2)” of the screen, which is specified by the area number in the in-area coordinate information, the cursor coordinate calculating unit 316 acquires actual coordinates on the screen indicated by “relative coordinates (0.5, 0.5)”. In the above case, it is assumed that the actual coordinates acquired by the cursor coordinate calculating unit 316 are (x2, y2).

Subsequently, the cursor coordinate calculating unit 316 outputs, to the whiteboard display control unit 312, information representing the converted actual coordinates, as a display position of the mouse cursor. The whiteboard display control unit 312 displays the mouse cursor on the screen of the display device 321, based on the converted actual coordinates (Step S402). Specifically, the cursor coordinate calculating unit 316 displays the mouse cursor at “actual coordinates (x2, y2)” corresponding to the middle of the area (A, 2). In this way, the position of the mouse cursor displayed by the cursor coordinate calculating unit 316 is as illustrated by a mouse cursor 521B on a screen 520B in FIG. 12.

The “point” indicated by the indication “mouse cursor display position 522 on the screen 520A”, which is displayed on the inner side of the area (B, 2) is a provisional indication for comparison. Specifically, the “point” as indicated by the display position 522 is not displayed on the actual screen 520B. The indication “mouse cursor display position 522 on the screen 520A” is displayed at the same coordinates as the actual coordinates (x1, y1) of the mouse cursor 521A on the screen 520A. This means that the mouse cursor may be displayed in the object residing in the area (B, 2) on the enlarged screen 520B, when the terminal device 310 displays the mouse cursor at the same actual coordinates (x1, y1) as in the terminal device 300, which is the sharing source. However, sharing the coordinates of a mouse cursor as relative coordinates, which is the in-area coordinate information, allows for the cursor coordinate calculating unit 316 to display the mouse cursor in such a manner that the positional relationship with respect to an object is maintained, as the screen 520B is enlarged. Specifically, according to the present exemplary embodiment, the problem described in the beginning part of the present exemplary embodiment such that a positional relationship between a position indication image and an object after enlargement may be deviated, does not occur.

When the shared display function of the mouse cursor is not ended, the cursor coordinate calculating unit 306 returns to Step S400, and repeats the procedure thereafter (Step S403).

In this way, the terminal device 310 performs a transmission operation in the shared display function of a mouse cursor.

As described above, the present exemplary embodiment has an advantage of allowing terminal devices which display screens with different enlargement ratios to draw objects in such a manner that the positional relationship between objects, and the positional relationship of a position indication image with respect to an object are not deviated, in addition to the same advantages as described in the first and second exemplary embodiments.

The above advantage is obtained because the enlargement process unit 304 controls enlargement in such a manner that a result of enlargement by the enlargement process lies in a range of maintaining the positional relationship between areas including each of the objects. Further, the above advantage is obtained because the cursor coordinate calculating units 306 and 316 calculate actual coordinates on screens enlarged with different enlargement ratios, based on in-area coordinate information through combining the area number for specifying an area and relative coordinates, the relative coordinates representing a position of the position indication image.

[Description on Addition of New Object]

In this section, a procedure to be performed by the shared server 400 and by each of the terminal devices when the user adds a new object on an enlarged screen of the terminal device 300 is described. When a new object is added, the terminal device 300 defines a display position of the new object designated by the user as in-area coordinates, and converts the in-area coordinates into actual coordinates in the same manner as the receiving operation in the shared display function of a position indication image as described above. The terminal device 300 adds object information relating to a new object generated based on actual coordinates after conversion to the drawing data 5 via the shared server 400. The object information is information relating to display of an object, as described in the first exemplary embodiment. The object information includes at least disposition information representing the display position of an object (coordinates on a screen), and size information representing the size of an object.

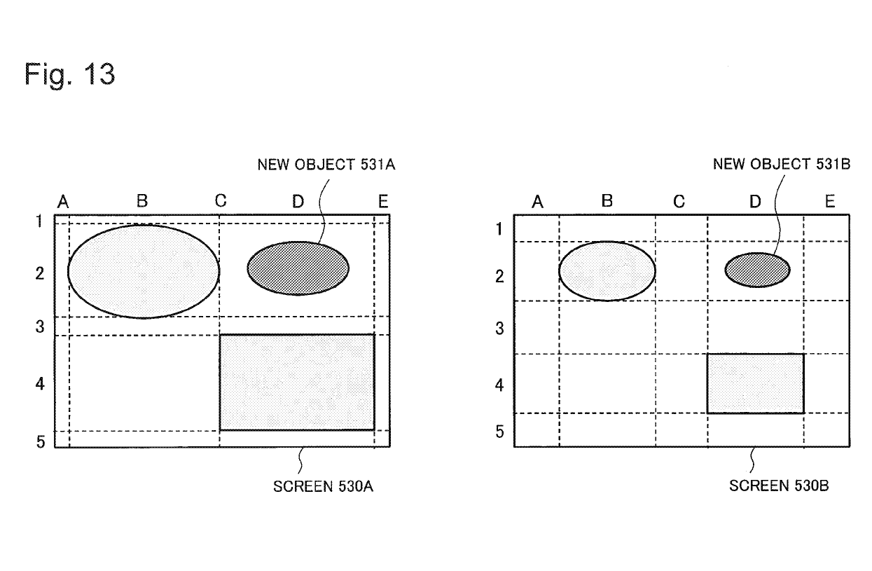

A concrete example relating to addition of a new object is described referring to FIG. 13. FIG. 13 is a diagram illustrating an example of a screen when a new object is added in the third exemplary embodiment. In FIG. 13, a screen 530A is a diagram representing that a new object 531A is added on an enlarged screen. Further, a screen 530B is a screen (hereinafter, called as “an original screen”) representing that the screen 530A is displayed with a size before enlargement.

For instance, when the user adds the new object 531A at an intended position on the enlarged screen 530A, the enlargement process unit 304 in the terminal device 300 converts into information representing a state that the new object is displayed on the original screen (new object 531B on the screen 530B). The above procedure is performed because the object information included in the drawing data 5 is information relating to display of an object on the original screen (before enlargement).

First of all, the enlargement process unit 304 converts actual coordinates of the new object 531A into in-area coordinates. Actual coordinates of a new object may be coordinates for specifying a position of the object on a screen. For instance, actual coordinates of a new object may be coordinates at a border position of the object, or may be coordinates at a center position of the object. The procedure of converting actual coordinates into in-area coordinates is the same as the procedure of converting coordinates in the transmission operation (Steps S300 to S302) in the shared display function of a position indication image.

The enlargement process unit 304 converts the converted in-area coordinates into actual coordinates on the original screen. The procedure of converting into actual coordinates is the same as the procedure of converting coordinates in the receiving operation (Steps S400 to S401) in the shared display function of a position indication image. Further, the enlargement process unit 304 also converts the size information of the object in accordance with the size of the original screen.

Subsequently, the enlargement process unit 304 outputs, to the whiteboard information communication unit 301, disposition information and size information based on the converted actual coordinates on the original screen. The whiteboard information communication unit 301 generates object information relating to a new object, including the received disposition information and size information. In this case, a new object is added. Therefore, it is highly likely that generated object information includes various information items necessary for displaying an object, such as shape information, image bitmap information, and color information. The whiteboard information communication unit 301 transmits the generated object information to the shared server 400.

The whiteboard information sharing unit 411 in the shared server 400 integrates the received object information relating to a new object into the drawing data 5. The whiteboard information sharing unit 411 transmits the integrated drawing data 5 to each of the terminal devices. In this way, the present exemplary embodiment makes it possible to add a new object on an enlarged screen, while maintaining the positional relationship with respect to an object before enlargement.

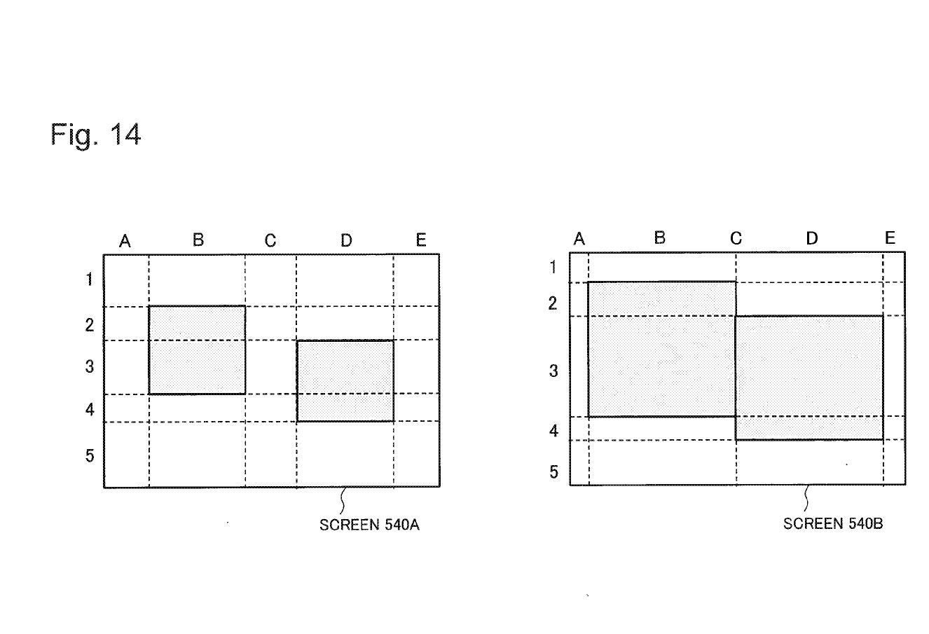

Further, as illustrated in FIG. 14, the present exemplary embodiment is also capable of enlarging a screen including objects whose coordinates are partly overlapped. FIG. 14 is a diagram illustrating an example of a screen when the screen including two objects whose coordinates are partly overlapped in the third exemplary embodiment. A screen 540A in FIG. 14 is an original screen before enlargement. The enlargement process unit 304 is capable of enlarging the screen 540A as an original screen to such a range that two objects away from each other come into contact with each other, as illustrated by a screen 540B. For instance, the enlargement process unit 304 may determine that the positional relationship is maintained until the margins of the area (C, 1) to the area (C, 5) disappear in Step S203.

[First Modification]

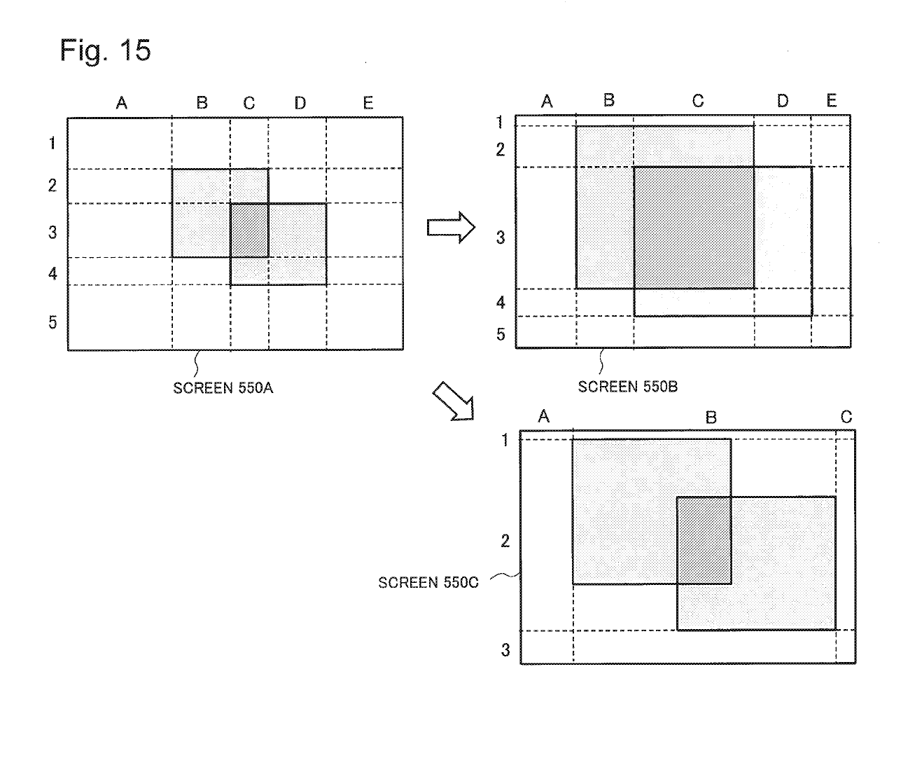

In a first modification of the present exemplary embodiment, as illustrated in FIG. 15, the terminal device 300 is capable of enlarging overlapping objects, while maintaining an overlapping ratio of the objects on a screen including the overlapping objects. FIG. 15 is a diagram illustrating an example of a screen when the screen including partly overlapping two objects is enlarged in the first modification of the third exemplary embodiment. A screen 550A in FIG. 15 is an original screen before enlargement. Further, a screen 550B is a screen when the two objects included in the screen 550A are respectively enlarged while fixing the center coordinates of each of the objects. When the screen 550A and the screen 550B are compared with each other, the overlapping ratio of two objects on the screen 550B is larger than the overlapping ratio of two objects on the screen 550A. In the present modification, the enlargement process unit 304 is capable of executing the process of maintaining an overlapping ratio of objects.

Specifically, the enlargement process unit 304 defines a rectangular area including the border of an object obtained by combining overlapping objects as one object, and enlarges the object while fixing the coordinates at the center position of the object. In the case of the screen 550A, the rectangular area is an area constituted of the areas (B, 2) to (D, 2), the areas (B, 3) to (D, 3), and the areas (B, 4) to (D, 4). Specifically, the enlargement process unit 304 executes an enlargement process, after area dividing is performed with respect to a screen after objects are combined as described above. The enlargement process unit 304 determines whether the positional relationship between areas is maintained with respect to a screen including a combined object, based on the divided areas. A screen 550C in FIG. 15 is a screen when an object obtained by combining overlapping two objects is enlarged.

In the example illustrated in FIG. 15, an object residing in the screen 550C is only a combined object. When there is only one object on a screen, the enlargement process unit 304 defines the inside of the frame of the screen as one area, and determines the positional relationship between areas. Specifically, the enlargement process unit 304 determines that the positional relationship is not maintained any longer, when one of the line segments serving as the sides of the area (B, 2) including an enlarged object on the screen 550C exceeds the frame of the screen. Alternatively, the enlargement process unit 304 may determine that the positional relationship between areas is not maintained any longer when one of the marginal areas (the areas (A, 1) to (A, 3), the areas (B, 1) and (B, 3), or the areas (C, 1) to (C, 3) on the screen 550C) disappears.

When the screen 550A and the screen 550C are compared with each other, the overlapping ratio of two objects is the same (maintained). Thus, the present modification has an advantage of enlarging display of objects whose display areas overlap each other, while maintaining the overlapping ratio of objects.

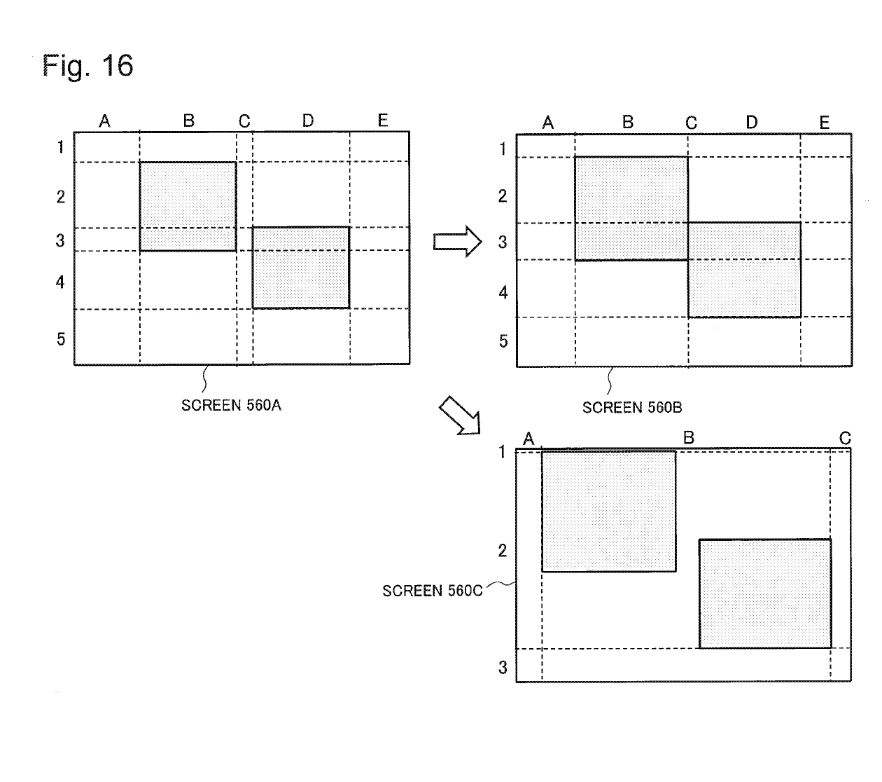

Further, as illustrated in FIG. 16, the present modification is capable of increasing the enlargement ratio on a screen including objects in proximity to each other. FIG. 16 is a diagram illustrating an example of a screen when the screen including two objects in proximity to each other is enlarged in the modification of the third exemplary embodiment. A screen 560A in FIG. 16 is an original screen before enlargement. Further, a screen 560B is a screen when each of the two objects included in the screen 560A is enlarged, while fixing the center coordinates of each of the objects. When two objects are in proximity to each other, as illustrated by the screen 560B after enlargement, the enlargement ratio is not so high, regardless of a relatively large marginal area around the objects. In the present modification, the enlargement process unit 304 may enlarge an object obtained by combining objects in proximity to each other. A screen 560C in FIG. 16 is a screen when an object obtained by combining two objects in proximity to each other is enlarged. When the screen 560B and the screen 560C are compared with each other, the enlargement ratio of the screen 560C is larger than the enlargement ratio of the screen 560B. In this way, the present modification has an advantage of increasing the enlargement ratio of display when there is a sufficient margin on a screen including objects in proximity to each other.

[Second Modification]

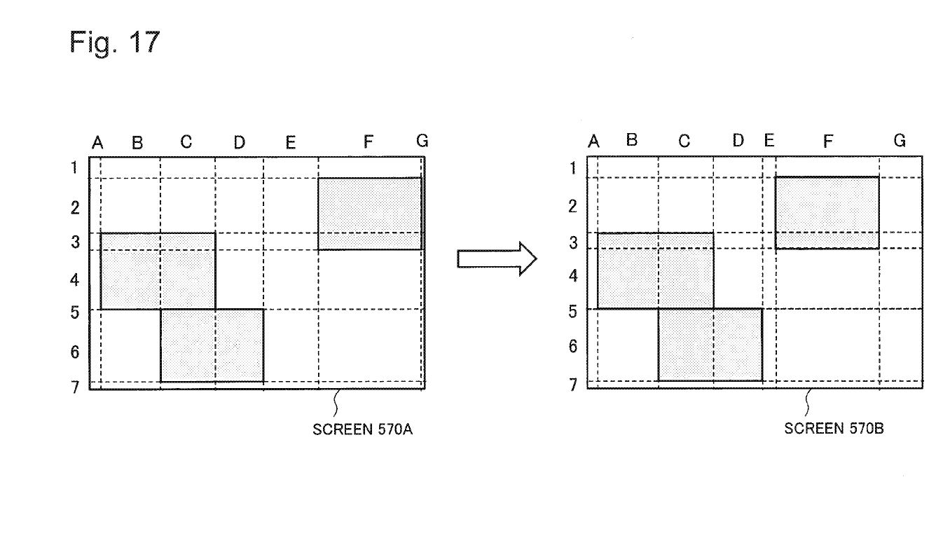

Further, in a second modification of the present exemplary embodiment, as illustrated in FIG. 17, it is possible to narrow a margin while maintaining the positional relationship between areas, when there remains a margin in the form of a belt, as a result of enlargement. FIG. 17 is a diagram illustrating an example of a screen when the display position of an object is changed with respect to a marginal area having a belt shape, as a result of enlargement. A screen 570A in FIG. 17 is a screen after enlargement as described in the first to third exemplary embodiments. The area (E, 1) to the area (E, 7) on the screen 570A is a marginal area that remains in the form of a belt. In this case, the enlargement process unit 304 may execute a process of narrowing the width of the area (E, 1) to the area (E, 7) for reducing the display area of an object on a screen. A screen 570B is an example of a screen when the display area of an object included in a screen is reduced in a horizontal direction by narrowing the width of the area (E, 1) to the area (E, 7). The positional relationship between areas is also maintained on the screen 570B. The enlargement process unit 304 broadens the area (G, 1) to the area (G, 7) by the width corresponding to the reduced width of the area (E, 1) to the area (E, 7). Alternatively, the enlargement process unit 304 may broaden the area (A, 1) to the area (A, 7), in place of the above.

The second modification is described as above.

In the foregoing exemplary embodiments and in the modifications, the respective units illustrated in FIG. 1, FIG. 2, and FIG. 5 may be constituted of hardware circuits independent of each other, or may be configured as functional (processing) units (software modules) of a software program. The respective units illustrated in the drawings of FIG. 1, FIG. 2, and FIG. 5 are configurations to simplify the description, and various configurations may be suggested when the units are actually mounted. An example of the hardware environment in the above case is described referring to FIG. 18. FIG. 18 is a diagram exemplifying a configuration of a computer which is applicable to the terminal devices and to the shared whiteboard system in the respective exemplary embodiments of the invention and in the modifications thereof. Specifically, FIG. 18 illustrates a configuration of a computer capable of implementing at least one of the terminal device 1, the terminal device 100, the terminal device 300, the terminal device 310, and the shared server 400 in the foregoing exemplary embodiments, and illustrates a hardware environment capable of implementing the respective functions in the respective exemplary embodiments.

A computer 900 illustrated in FIG. 18 is provided with a CPU (Central Processing Unit) 901, an ROM (Read Only Memory) 902, an RAM (Random Access Memory) 903, a communication interface (I/F) 904, a display 905, and a hard disk device (HDD) 906; and includes a configuration such that these units are connected to each other via a bus 907. When the computer illustrated in FIG. 18 functions as the shared server 400, it is not necessary to install the display 905 all the time. Further, the communication interface 904 is a general communication unit which implements communications between the computers in the respective exemplary embodiments. A program group 906A and various storage information items 906B are stored in the hard disk device 906. The program group 906A is, for instance, a computer program for implementing the functions associated with the respective blocks (respective units) illustrated in FIG. 1, FIG. 2, and FIG. 5. The various storage information items 906B are information items such that the drawing data 5 and the like is temporarily stored when the respective units illustrated in FIG. 1, FIG. 2, and FIG. 5 are operated. The CPU 901 controls the overall operation of the computer 900 in the hardware configuration as described above.

The invention described by the examples of the respective exemplary embodiments is accomplished by supplying a computer program capable of implementing the functions of the block configuration diagrams (FIG. 1, FIG. 2, and FIG. 5) or the flowcharts (FIG. 3, and FIG. 7 to FIG. 9) which have been referred to in describing the respective exemplary embodiments, and by causing the CPU 901 as a hardware resource to read the computer program for execution. Further, the computer program supplied to the computer may be stored in the readable and writable temporary storage memory 903 or in a non-volatile storage device (storage medium) such as the hard disk device 906.

Further, in the foregoing configuration, the method for supplying a computer program to the respective devices may be a currently available general method, such as a method for installing the computer program in the device via various recording media such as a floppy disk (registered trademark) or a CD-ROM, and a method for downloading the computer program from the outside via the communication network 1000 such as the Internet. In the above configuration, the present invention may be construed as codes configuring the computer program, or as a computer-readable storage medium in which the codes are recorded.

Part or all of the foregoing exemplary embodiments may be described as the following Supplemental Notes. The present invention described by the exemplary embodiments, however, is not limited to the following.

(Supplemental Note 1)

An information processing device includes:

an input control unit which calculates an enlargement ratio, based on an instruction to enlarge objects displayed on a screen of a display device, and generates enlargement instruction information including enlargement ratio information representing the enlargement ratio;

an enlargement process unit which executes an enlargement process of enlarging a plurality of objects in drawing data in a state that the objects do not overlap each other, based on the enlargement ratio information and the drawing data including object information relating to display of the objects, and generates enlarged drawing data including object information relating to the enlarged objects; and

a display control unit which displays the enlarged objects on a screen of the display device, based on the enlarged drawing data.

(Supplemental Note 2)

The information processing device according to Supplemental Note 1, wherein

the enlargement process unit maintains a positional relationship between centers of the objects when the enlargement process is executed.

(Supplemental Note 3)

The information processing device according to Supplemental Note 1 or 2, wherein

the enlargement process unit executes an area dividing process of dividing the screen into a plurality of areas by sandwiching each object by two line segments in parallel to each of coordinate axes on the screen before the enlargement process is executed, and controls enlargement in such a manner that a result of enlargement of the objects by execution of the enlargement process lies in a range of maintaining a positional relationship between the areas including the objects.

(Supplemental Note 4)

The information processing device according to Supplemental Note 3, further includes:

a coordinate calculating unit which converts actual coordinates of a position indication image on the screen into in-area coordinate information, through combining an area number representing information for identifying the area and relative coordinates, the relative coordinates representing a position of position indication image in the area specified by the area number; and

a communication unit which transmits, to a server, the in-area coordinate information with respect to another information processing device that shares the drawing data via the server.

(Supplemental Note 5)

The information processing device according to Supplemental Note 4, wherein

the communication unit receives, from the server, the in-area coordinate information with respect to a position indication image displayed on a screen of another information processing device, and

the coordinate calculating unit calculates actual coordinates on the screen, based on the received in-area coordinate information, and outputs, to the display control unit, position coordinate information representing the calculated actual coordinates.

(Supplemental Note 6)

The information processing device according to any one of Supplemental Notes 3 to 5, wherein

the enlargement process unit executes an area dividing process, assuming that a rectangular area including a border of an object obtained by combining a plurality of overlapping objects is an object in the area dividing process.

(Supplemental Note 7)

The information processing device according to any one of Supplemental Notes 3 to 6, wherein

the enlargement process unit narrows a width of a marginal area to change display positions of the objects, when the marginal area excluding the objects has a belt shape, as a result of execution of the enlargement process.

(Supplemental Note 8)

A display enlarging method includes:

calculating an enlargement ratio, based on an instruction to enlarge objects displayed on a screen of a display device;

executing an enlargement process of enlarging a plurality of objects in drawing data in a state that the objects do not overlap each other, based on enlargement instruction information including enlargement ratio information representing the enlargement ratio and the drawing data including object information relating to display of the objects; and

displaying enlarged objects on a screen of the display device, based on enlarged drawing data including object information relating to the enlarged object.

(Supplemental Note 9)

The display enlarging method according to Supplemental Note 8, wherein

a positional relationship between centers of the objects is maintained when the enlargement process is executed.

(Supplemental Note 10)

The display enlarging method according to Supplemental Note 8 or 9, further includes:

executing an area dividing process of dividing the screen into a plurality of areas by sandwiching each object by two line segments in parallel to each of coordinate axes on the screen before executing the enlargement process, and

controlling the enlargement process in such a manner that a result of enlargement of the objects by execution of the enlargement process lies in a range of maintaining a positional relationship between the areas including the objects.

(Supplemental Note 11)

The display enlarging method according to Supplemental Note 10, wherein

actual coordinates of a position indication image on the screen are converted into the in-area coordinate information, through combining an area number representing information for identifying the area and relative coordinates, the relative coordinates representing a position of the position indication image in the area specified by the area number, and

the in-area coordinate information with respect to another information processing device that shares the drawing data via a server is transmitted to the server.

(Supplemental Note 12)

The display enlarging method according to Supplemental Note 11, wherein

in-area coordinate information with respect to a position indication image displayed on a screen of another information processing device is received from the server, and

actual coordinates on the screen are calculated, based on the received in-area coordinate information, and position coordinate information representing the calculated actual coordinates is output to the screen.

(Supplemental Note 13)

The display enlarging method according to any one of Supplemental Notes 10 to 12, wherein

an area dividing process is executed, assuming that a rectangular area including a border of an object obtained by combining a plurality of overlapping objects is an object in the area dividing process.

(Supplemental Note 14)

The display enlarging method according to any one of Supplemental Notes 10 to 13, wherein

a width of a marginal area is narrowed to change display positions of the objects, when the marginal area excluding the object has a belt shape, as a result of execution of the enlargement process.

(Supplemental Note 15)

A no-transitory computer readable medium for storing a computer program which causes an information processing device to execute:

an input control process of calculating an enlargement ratio, based on an instruction to enlarge objects displayed on a screen of a display device, and generating enlargement instruction information including enlargement ratio information representing the enlargement ratio;

an enlargement process of enlarging a plurality of objects in drawing data in a state that the objects do not overlap each other, based on the enlargement ratio information and the drawing data including object information relating to display of the objects; and

a display control process of displaying enlarged objects on a screen of the display device, based on enlarged drawing data including object information relating to the enlarged objects.

(Supplemental Note 16)

The computer readable medium according to Supplemental Note 15, wherein

a positional relationship between centers of the objects is maintained when the enlargement process is executed.

(Supplemental Note 17)

The computer readable medium according to Supplemental Note 15 or 16, the computer program which causes an information processing device to execute:

an area dividing process of dividing the screen into a plurality of areas by sandwiching each object by two line segments in parallel to each of coordinate axes on the screen before the enlargement process is executed, and

a control process of controlling enlargement in such a manner that a result of enlargement of the object by execution of the enlargement process lies in a range of maintaining a positional relationship between the areas including the objects is executed.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. An information processing device comprising:
an input control unit which calculates an enlargement ratio, based on an instruction to enlarge objects displayed on a screen of a display device, and generates enlargement instruction information including enlargement ratio information representing the enlargement ratio;
an enlargement process unit which executes an enlargement process of enlarging a plurality of objects in drawing data in a state that the objects do not overlap each other, based on the enlargement ratio information and the drawing data including object information relating to display of the objects, and generates enlarged drawing data including object information relating to the enlarged objects; and
a display control unit which displays the enlarged objects on a screen of the display device, based on the enlarged drawing data.

2. The information processing device according to claim 1, wherein
the enlargement process unit maintains a positional relationship between centers of the objects when the enlargement process is executed.

3. The information processing device according to claim 1, wherein
the enlargement process unit executes an area dividing process of dividing the screen into a plurality of areas by sandwiching each object by two line segments in parallel to each of coordinate axes on the screen before the enlargement process is executed, and controls enlargement in such a manner that a result of enlargement of the objects by execution of the enlargement process lies in a range of maintaining a positional relationship between the areas including the objects.

4. The information processing device according to claim 2, wherein
the enlargement process unit executes an area dividing process of dividing the screen into a plurality of areas by sandwiching each object by two line segments in parallel to each of coordinate axes on the screen before the enlargement process is executed, and controls enlargement in such a manner that a result of enlargement of the objects by execution of the enlargement process lies in a range of maintaining a positional relationship between the areas including the objects.

5. The information processing device according to claim 3, further comprising:
a coordinate calculating unit which converts actual coordinates of a position indication image on the screen into in-area coordinate information, through combining an area number representing information for identifying the area and relative coordinates, the relative coordinates representing a position of position indication image in the area specified by the area number; and
a communication unit which transmits, to a server, the in-area coordinate information with respect to another information processing device that shares the drawing data via the server.

6. The information processing device according to claim 4, further comprising:
a coordinate calculating unit which converts actual coordinates of a position indication image on the screen into in-area coordinates, through combining an area number representing information for identifying the area and relative coordinates, the relative coordinates representing a position of position indication image in the area specified by the area number; and
a communication unit which transmits, to a server, the in-area coordinate information with respect to another information processing device that shares the drawing data via the server.

7. The information processing device according to claim 5, wherein
the communication unit receives, from the server, the in-area coordinate information with respect to a position indication image displayed on a screen of another information processing device, and
the coordinate calculating unit calculates actual coordinates on the screen, based on the received in-area coordinate information, and outputs, to the display control unit, position coordinate information representing the calculated actual coordinates.

8. The information processing device according to claim 6, wherein
the communication unit receives, from the server, the in-area coordinate information with respect to a position indication image displayed on a screen of the another information processing device, and
the coordinate calculating unit calculates actual coordinates on the screen, based on the received in-area coordinate information, and outputs, to the display control unit, position coordinate information representing the calculated actual coordinates.

9. A display enlarging method comprising:
calculating an enlargement ratio, based on an instruction to enlarge objects displayed on a screen of a display device;
executing an enlargement process of enlarging a plurality of objects in drawing data in a state that the objects do not overlap each other, based on enlargement instruction information including enlargement ratio information representing the enlargement ratio and the drawing data including object information relating to display of the objects; and
displaying enlarged objects on a screen of the display device, based on enlarged drawing data including object information relating to the enlarged object.

10. The display enlarging method according to claim 9, wherein
a positional relationship between centers of the objects is maintained when the enlargement process is executed.

11. The display enlarging method according to claim 9, further comprising:
executing an area dividing process of dividing the screen into a plurality of areas by sandwiching each object by two line segments in parallel to each of coordinate axes on the screen before the enlargement process is executed, and
controlling the enlargement process in such a manner that a result of enlargement of the objects by execution of the enlargement process lies in a range of maintaining a positional relationship between the areas including the objects.

12. The display enlarging method according to claim 10, further comprising:
executing an area dividing process of dividing the screen into a plurality of areas by sandwiching each object by two line segments in parallel to each of coordinate axes on the screen before the enlargement process is executed, and
controlling the enlargement process in such a manner that a result of enlargement of the objects by execution of the enlargement process lies in a range of maintaining a positional relationship between the areas including the objects.

13. A no-transitory computer readable medium for storing a computer program which causes an information processing device to execute:
an input control process of calculating an enlargement ratio, based on an instruction to enlarge objects displayed on a screen of a display device, and generating enlargement instruction information including enlargement ratio information representing the enlargement ratio;
an enlargement process of enlarging a plurality of objects in drawing data in a state that the objects do not overlap each other, based on the enlargement ratio information and the drawing data including object information relating to display of the objects; and
a display control process of displaying enlarged objects on a screen of the display device, based on enlarged drawing data including object information relating to the enlarged objects.

14. The computer readable medium according to claim 13, the computer program which causes the information processing device to execute:
an area dividing process of dividing the screen into a plurality of areas by sandwiching each object by two line segments in parallel to each of coordinate axes on the screen before the enlargement process is executed, and
a control process of controlling enlargement in such a manner that a result of enlargement of the object by execution of the enlargement process lies in a range of maintaining a positional relationship between the areas including the objects is executed.
